(19) United States
(12) Patent Application Publication
(10) Pub. No.: US 2012/0226832 A1
(43) Pub. Date: Sep. 6, 2012

(54) DATA TRANSFER DEVICE, FT SERVER AND DATA TRANSFER METHOD

(75) Inventor: Ryuta Niino, Tokyo (JP)

(73) Assignee: NEC Corporation, Tokyo (JP)

(21) Appl. No.: 13/411,413

(22) Filed: Mar. 2, 2012

(30) Foreign Application Priority Data
Mar. 3, 2011 (JP) 2011-045944

(51) Int. Cl. G06F 13/00

(52) U.S. Cl. 710/33

(57) ABSTRACT

A data transfer device includes a transfer method setter that sets the transfer method to either a first transfer method or second transfer method that differ from each other, and a transfer controller that causes data to be transferred. The transfer controller causes data to be transferred according to the transfer method that was set by the transfer method setter. The first transfer method, for example, is a transfer method that has a smaller expected writing disabled time than the second transfer method when the probability that writing will occur during the transfer process is high. The second transfer method, for example, is a transfer method that has a smaller expected writing disabled time than the first transfer method when the probability that writing will occur during the transfer process is low.

### CROSS-REFERENCE TO RELATED APPLICATION

This application claims the benefit of Japanese Patent Application 2011-045944, filed on 2011 Feb. 3, the entire disclosure of which is incorporated by reference herein.

### FIELD

This application relates to a data transfer device, an FT server that comprises that data transfer device, and a method of transferring data.

### BACKGROUND

Fault tolerant servers (FT servers) are widely used in order to increase the availability of computer systems. A fault tolerant server comprises double or multiple redundancy of hardware such as the CPU, main memory and the like. In an FT server, data such as data that indicates the state of the CPU of the main system, and memory data that is stored in the main memory is transferred to another system. As a result, the CPU, main memory and the like of each system are maintained in the same state, so that even though trouble may occur in the main system, it is possible for the other system to continue processing after that.

As a method for transferring update data at any time is a checkpoint method that transfers data at a predetermined time (checkpoint). For example, a checkpoint type method of transferring cache data that is stored in the processor to another system is disclosed in Unexamined Japanese Patent Application Kokai Publication No. H7-271624. In this method, each time when the cache data is updated, the updated contents are written in the main memory. At the checkpoint time, all of the updated contents of the cache data that is stored in the main memory are transferred together to another system

However, when a write request to write data to the memory occurs during the transfer process, a period of time occurs during which the write request is caused to wait (hereafter this will be referred to as the writing disabled time). This kind of writing disabled time particularly increases when the frequency of writing to memory is high.

### SUMMARY

In consideration of the situation above, the object of the present invention is to provide a data transfer device that is capable of shortening the writing disabled time when transferring data that is to be from a memory, which stores the data to be transferred, to a memory of another device.

In order to accomplish the object of the invention above, the data transfer device according to a first aspect of the present invention is a data transfer device comprising: a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and a transfer controller that causes the data to be transferred to be transferred from a memory that stores the data to be transferred to the memory of another device according to the transfer method that was set by the transfer method setter.

Moreover, the FT server according to a second aspect of the present invention is an FT server, comprising: a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and a transfer controller that causes the data to be transferred to be transferred from a memory that stores the data to be transferred to the memory of another device according to the transfer method that was set by the transfer method setter.

Furthermore, the data transfer method according to a third aspect of the present invention is a data transfer method that references writing occurrence data that indicates a value according to the probability that writing to the memory where the data to be transferred will occur while data is being transferred; sets a transfer method that is either a first transfer method or a second transfer method that is different from the first transfer method based on the value that is indicated by the referenced writing occurrence data; and causes the data to be transferred to be transferred from a memory that stores the data to be transferred to a memory of another device according to the set transfer method.

With the present invention, a first transfer method or a second transfer method that are different from each other is set, and data is transferred according to the set transfer method. The transfer method is set based on a value according to the probability that writing will occur during the data transfer process. As a result, it is possible to set the transfer method according to the access trend for accessing data to be transferred. Therefore, when transferring data to be transferred from the memory that stores the data to be transferred to the memory of another device, it is possible to shorten the write disabled time.

### BRIEF DESCRIPTION OF THE DRAWINGS

A more complete understanding of this application can be obtained when the following detailed description is considered in conjunction with the following drawings, in which:

FIG. 1 is a drawing illustrating an example of the construction of an FT server of a first embodiment of the present invention;

FIG. 2 is a drawing illustrating an example of page table data of the first embodiment;

FIG. 3 is drawing illustrating an example of segment table data of the first embodiment;

FIG. 4 is a drawing illustrating an example of last dirty page data of the first embodiment;

FIG. 5 is a drawing illustrating the detailed construction of a main controller of the first embodiment;

FIG. 6 is a drawing illustrating the detailed construction of a DP counter of the first embodiment;

FIG. 7 is a drawing illustrating the detailed construction of a transfer method setter of the first embodiment;

FIG. 8 is a drawing illustrating the detailed construction of a memory data updater of the first embodiment;

FIG. 9 is a drawing illustrating the detailed construction of a transfer controller of the first embodiment;

FIG. 10 is a flowchart illustrating an example of processing that is executed at the checkpoint time by the first system of the first embodiment;

FIG. 11 is a drawing that schematically illustrates a state identified by the memory data of a dirty page;

FIG. 12 is a drawing that schematically illustrates a state wherein the write inhibit flag is set;

FIG. 13 is a flowchart illustrating in detail the bulk copy transfer process of the first embodiment;

FIG. 14 is a drawing that schematically illustrates a state wherein memory data of a dirty page is locally copied in a save area in the bulk copy transfer process;

FIG. 15 is a drawing that schematically illustrates a state wherein the dirty flag and the write inhibit flag are cleared in the bulk copy transfer process;

FIG. 16 is a drawing that schematically illustrates a state wherein memory data of a dirty page is transferred in the bulk copy transfer process;

FIG. 17 is a flowchart illustrating in detail the COW transfer process in the first embodiment;

FIG. 18 is a drawing that schematically illustrates a state wherein memory data of a dirty page is transferred for which a write request did not occur in the COW transfer process;

FIG. 19 is a drawing that schematically illustrates a state wherein a write request to write to a not yet transferred dirty page occurred in the COW transfer process;

FIG. 20 is a drawing the schematically illustrates a state wherein memory data of a not yet transferred dirty page for which a write request occurred is locally copied to a save area in the COW transfer process;

FIG. 21 is a drawing that schematically illustrates a state wherein memory data of a dirty page is transferred for which a write request occurred in the COW transfer process;

FIG. 22 is a drawing that schematically illustrates a state after memory data of a dirty page that had a write request has been transferred in the COW transfer process;

FIG. 23 is a flowchart that illustrates in detail the transfer update process in the first embodiment;

FIG. 24 is a flowchart that illustrates the memory data update process in the first embodiment;

FIG. 25 is a drawing illustrating an example of page table data in a second embodiment;

FIG. 26 is a drawing illustrating the detailed construction of the main controller in the second embodiment;

FIG. 27 is a drawing illustrating the detailed construction of the transfer controller in the second embodiment;

FIG. 28 is a flowchart that illustrates an example of processing that is executed at the checkpoint time by the first system in the second embodiment;

FIG. 29 is a flowchart that illustrates in detail the bulk copy transfer process in a second embodiment;

FIG. 30 is a flowchart that illustrates in detail the COW transfer process in a second embodiment;

FIG. 31 is a flowchart that illustrates the memory data update process in the second embodiment; and

FIG. 32 is a flowchart that illustrates the new segment adding process in the second embodiment.

### DETAILED DESCRIPTION

In the following, embodiments of the present invention will be explained with reference to the drawings.

### Embodiment 1

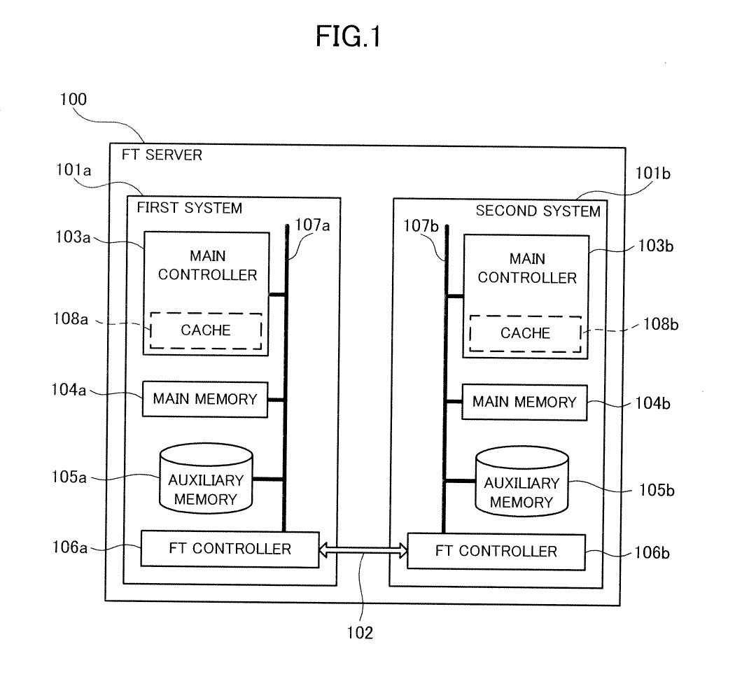

The fault tolerant server (FT server) of a first embodiment of the present invention will be explained with reference to FIG. 1 to FIG. 25.

As illustrated in FIG. 1, the FT server 100 of this embodiment comprises a first system 101a and a second system 101b. The first system 101a and second system 101b are connected by a communication bus 102 for exchanging data.

In the case of the FT server 100 of this embodiment, normally, the first system 101a operates as the main system, and the second system 101b waits as a sub system. At the time of a checkpoint, the first system 101a transfers data such as memory data that is stored in a main memory 104a, context data that indicates the state of the main controller 103a, and the like to the second system 101b via the communication bus 102. In other words, the first system 101a that operates as the main system in this embodiment is an example of a data transfer device.

In this embodiment, data to be matched (data to be transferred) between the first system 101a and the second system 101b is data in the main memory unit 104a; for example, is data in the main memory unit 104a that a guest OS that is executed by the first system 101a uses.

A checkpoint is a time that is appropriately set by a user or the like for transferring data. A checkpoint can be set periodically for example. When a checkpoint occurs, the state of both systems 101a, 101b become the same. Therefore, when trouble occurs in the first system 101a that normally operates, after that, the second system 101b becomes the main system, and can continue processing from the state at the time of the checkpoint just before the trouble occurred. Then, when the first system 101a recovers, that recovered first system (101a) waits as the sub system.

As illustrated in FIG. 1, the first system 101a and the second system 101b comprise the same construction. Each system 101a (101b) comprises: a main controller 103a (103b), a main memory 104a (104b), an auxiliary memory 105a (105b), and an FT controller 106a (106b). These units 103a to 106a (103b to 106b) are connected via an internal bus 107a (107b) for exchanging data.

The main controller 103a (103b) executes various kinds of data processing, controls all of the units, and manages and updates the memory areas of the main memory 104a (104b). The main controller 103a (103b) is achieved by a CPU (Central Processing Unit), MPU (Micro-Processing Unit) and/or the like. The main controller 103a (103b) can also be achieved by a combination of a MMU (Main Management Unit), LSI (Large Scale Integration) for DMA (Direct Memory Access) transfer, and the like.

The main controller 103a (103b), as illustrated in FIG. 1, comprises a cache 108a (108b). The cache 108a (108b) is a memory to which the main controller 103a (103b) can read or write data at high speed; for example, includes an TLB (Translation Lookaside Buffer) that stores page table data.

The page table data that the cache 108a (108b) stores is data that includes a table for managing pages of the main memory 104a (104b). A page is a memory area having a fixed size (for example 4 KBytes) that is typically used for managing the memory areas of the main memory 104a (104b), and in this embodiment, a page is the transfer unit for transferring memory data. By transferring data in page units, high-speed transfer processing becomes possible.

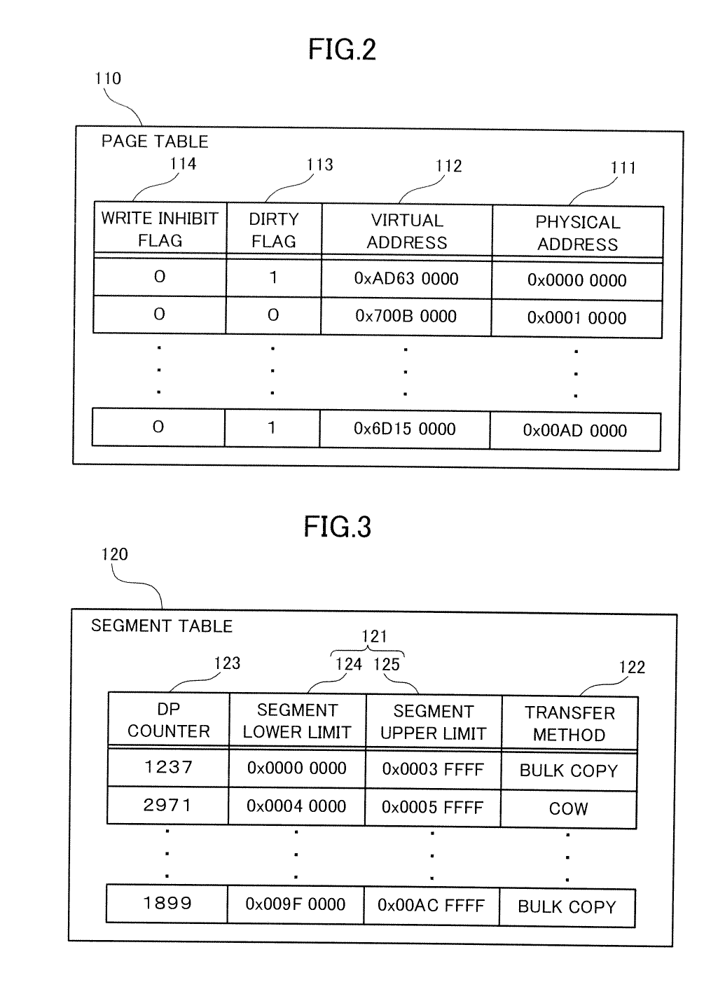

FIG. 2 illustrates an example of page table data (transfer unit table data) in this embodiment. The page table data 110, as illustrated in FIG. 2, includes physical address data 111, virtual address data 112, dirty flag data 113 and write inhibit flag data 114. Each kind of data 111 to 114 in the page data table 110 is correlated per page.

Physical address data 111 is data for identifying each page in the memory areas of the main memory 104a (104b). Physical address data 111 identifies each page by a physical address. The physical address data 111 in this embodiment indicates the physical addresses that are the start of each page. In this embodiment, the page size is fixed as described above, so physical address data 111 that indicates the start of a page can be used to identify each of the pages in the main memory 104a (104b).

In FIG. 2, for example, “0x0000 0000” indicates an address that is represented by the hexadecimal number “0000 0000”. This is the same in the other figures as well.

Virtual address data 112, like physical address data 111, is data for identifying pages in the memory areas of virtual memory in the main memory 104a (104b). Virtual address data 112 is correlated with physical address data 111. Virtual address data 112 identifies a page using a virtual address. Virtual address data 112 in this embodiment, as in the case of using physical addresses above, indicates the virtual addresses at the start of the pages.

Dirty flag data (first dirty data) 113 is data that can identify dirty pages. A dirty page is a page for which writing occurred at a specified time. For each page, whether or not the page is a dirty page is determined according to the state of the dirty flag. The counting time, which is a break between specified times for determining whether or not there was writing, can be arbitrarily set, and in this embodiment, counting times coincide with checkpoints. In other words, a dirty page is a page for which writing occurred between the previous checkpoint (counting time) and the current checkpoint (counting time). Writing includes deleting part or all contents, updating contents and the like.

In this embodiment, when the dirty flag indicated by dirty file data 113 is raised (is ‘1’), the page correlated with that dirty flag data 113 is a dirty page. On the other hand, when the dirty flag indicated by dirty file data 113 is not raised (is ‘0’), the page correlated with that dirty file data 113 is not a dirty page. In this embodiment, whether or not writing occurred during a specified period of time is determined; however, there are cases where writing may occur multiple times during a specified period of time. Therefore, the dirty flag can also be a counter that indicates the number of times writing occurred during a specified period of time.

Write inhibit flag data 114 is data that indicates the state of a write inhibit flag. A write inhibit flag indicates whether or not writing is inhibited for a page. In this embodiment, when the write inhibit flag indicated by the write inhibit flag data 114 is raised (is ‘1’), writing is inhibited for the page correlated with that write inhibit flag data 114. When the write inhibit flag is not raised (is writing is allowed for the page correlated with that write inhibit flag data 114.

The main memory 104a (104b) illustrated in FIG. 1 is a memory to or from which the main controller 103a (103b) reads or writes data. The main memory 104a (104b) is achieved by RAM (Random Access Memory) or the like.

The memory areas of the main memory 104a (104b) include guest OS areas as target transfer areas, save areas, and the like. A guest OS area is a guest OS area that is used by a guest OS (Operating System). A save area is an area for temporarily saving data.

The main memory 104a (104b) of this embodiment stores segment table data. Segment table data is data that indicates a segment table for managing segments. A segment is an area resulting from dividing the target transfer area of the main memory 104a (104b). A segment comprises one or more pages (transfer units).

FIG. 3 illustrates an example of segment table data of this embodiment. Segment table data 120 includes segment ID data 121, transfer method data 122, and dirty page counter (DP counter) data 123. All of the kinds of data 121 to 123 of the segment table data 120 are correlated per segment.

Segment ID data 121 is data for identifying segments in the memory areas of the main memory 104a (104b). Segment ID data 121 of this embodiment includes segment lower limit data 124 and segment upper limit data 125. The segment lower limit data 124 and segment upper limit data 125 indicate the physical addresses that are the lower limit and upper limit of a segment. A segment in this embodiment comprises the area from the segment lower limit data 124 to the segment upper limit data 125.

Transfer method data 122 is data that indicates the method of transferring the data included in a segment that is to be transferred to the second system 101b.

The transfer method in this embodiment is either the bulk copy transfer method or Copy On Write (COW) transfer method.

In the bulk copy transfer method, when a checkpoint occurs, the main system first copies (local copy) together the memory data of all of the dirty pages at that time to the save area of the main memory 104a. Then the main system clears the dirty flag and continues with processing after the checkpoint. While continuing the processing after the checkpoint, the main system transfers the locally copied memory data for each page in order to the sub system.

In the COW transfer method, when a checkpoint occurs, the main system transfers memory data of dirty pages in order per page to the sub system. Then, when a write request to write to a page that has not yet been transferred occurs while in the progress of orderly transferring data, the main system locally copies the memory data before the write request to that page. The write request is processed after the local copy has been performed. The main system then transfers the locally copied memory data of the page that has not been transferred (page for which the write request occurred) to the sub system.

The DP counter data 123 is data that indicates the value of the DP counter that counts the number of pages for which writing that satisfies specified conditions was performed for each segment. In this embodiment, the value of the DP counter is the value of the number of pages for which a dirty flag was raised continuously for two checkpoints (counting periods) that was counted for each segment. In other words, in the present invention, the specified condition is that a dirty flag be raised continuously for two checkpoints (counting periods). The DP counter data 123 is an example of frequency data that indicates the frequency at which writing that satisfies a specified condition occurred for pages included in each segment.

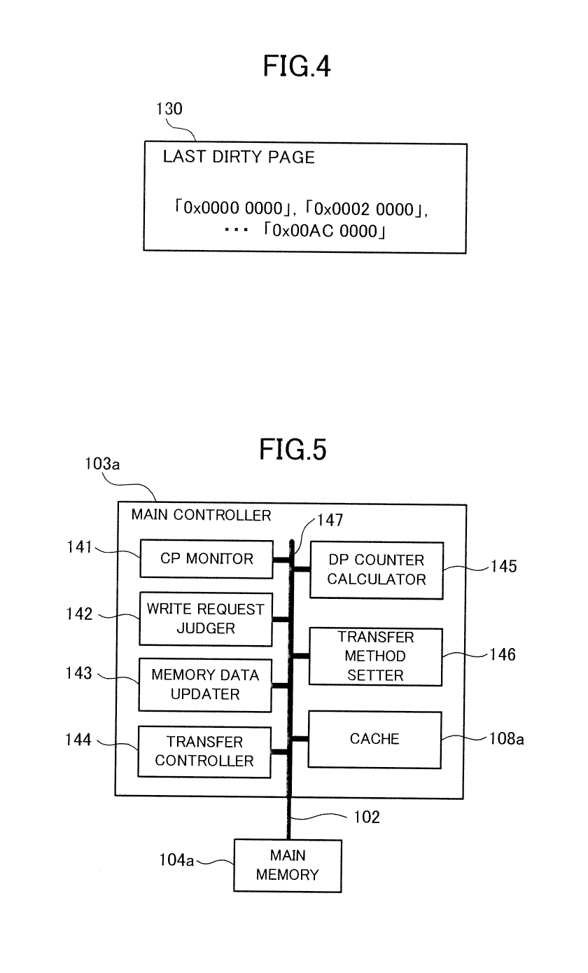

The main memory 104a (104b) of this embodiment, further stores last dirty page data (second dirty data). Last dirty data is data that can identify the last dirty page. The last dirty page is a page for which writing occurred between the checkpoint (counting period) before the previous checkpoint and the previous checkpoint (counting period). FIG. 4 illustrates an example of last dirty page data 130 of this embodiment. The last dirty page data 130 indicates a physical address for each last dirty page.

The main memory 104a (104b) of this embodiment further stores checkpoint counter (CP counter) data. CP counter data is data that indicates the number of times checkpoints occurred (number of times transfer was performed) after the transfer method data 122 of the segment table data 120 was written.

The auxiliary memory 105a (105b) illustrated in FIG. 1 is a large-capacity memory that stores various data, including computer programs such as application software and the like. The auxiliary memory 105a (105b) is achieved by a HDD (Hard Disk Drive) or the like.

The FT controller 106a (106b) exchanges data between each system 101a, 101b, and performs control for that. The FT controller 106a (106b) is achieved by an FT control LSI or the like.

The FT controller 106a (106b) includes a data transfer unit that acquires memory data of a dirty page in the main memory 104a (104b) according to control from the main controller 103a (103b), and transfers the acquired memory data to the other system 101b (101a) via the communication bus 102. The transferred memory data is acquired by the FT controller 106b (106a) of the other system 101b (101a) and stored in the main memory 104b (104a).

The detailed construction of the main controller 103a of this embodiment will be explained below with reference to FIG. 5 to FIG. 9.

As illustrated in FIG. 5, the main controller 103a comprises a CP monitor 141, a write request judger 142, a memory data updater 143, a transfer controller 144, a DP counter calculator 145 and a transfer method setter 146 as a controller or processor. Each controller or processor 141 to 146 in the main controller 103a and the cache 108a are connected via an internal bus 147 so that they can exchange data.

When a checkpoint occurs, the DP counter calculator 145 counts, for each segment, the number of pages satisfying a specified condition and for which a dirty flag was raised. The transfer method setter 146 sets the transfer method for each segment based on the DP counter for each specified period. When a checkpoint occurs, the transfer controller 144 transfers the dirty pages for a segment to the second system 101b according to the transfer method set for that segment. When a write request occurs, the memory data updater 143 determines whether or not a write inhibit flag was raised for the page for which there was a write request, and when the write inhibit flag is not raised, writes data. The details are explained below.

The CP monitor 141 monitors whether or not a checkpoint has occurred. When a checkpoint occurs, the CP monitor 141 sends data to the CP counter calculator 145, the transfer method setter 146 and the transfer controller 144 indicating that a checkpoint occurred.

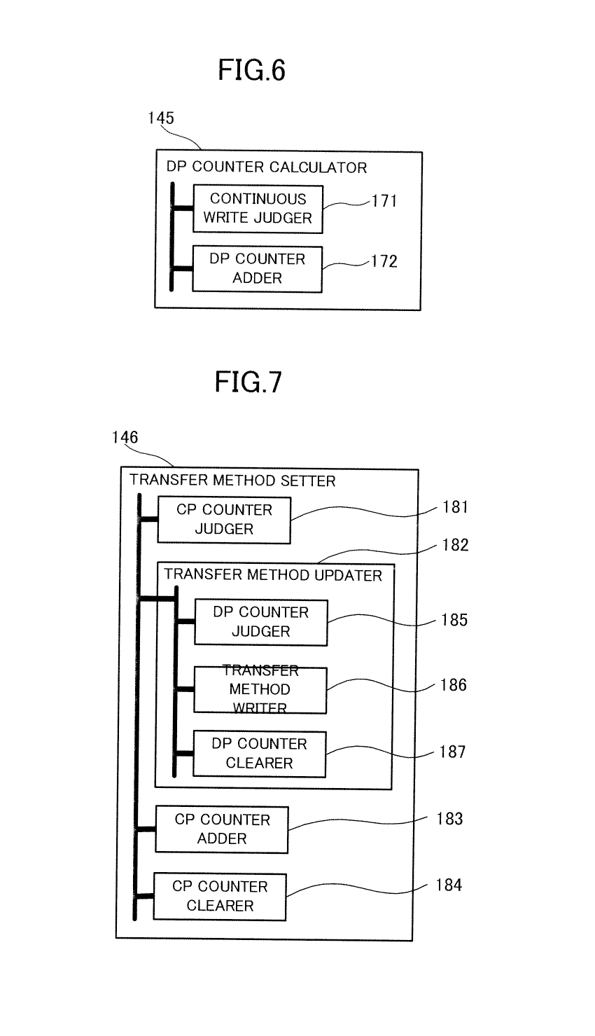

The DP counter calculator (write occurrence counter) 145, after receiving data from the CP monitor 141 that indicates that a checkpoint (counting period) has occurred, identifies the segments for which writing has occurred, and calculates the writing frequency for each segment. The DP counter calculator 145 then generates data that indicates the calculated value, and sets the generated data as DP counter data 123 of the segment table data 120. As illustrated in FIG. 6, the DP counter calculator 145 comprises a continuous write judger 171 and a DP counter adder 172.

The continuous write judger 171 determines for each page whether or not writing that satisfies the specified condition above has occurred. The continuous write judger 171 of this embodiment references the last dirty page data 130 and the dirty flag data 113 in the page table data 110, and determines for each page whether or not writing has occurred continuously for two checkpoints (count periods).

When it is determined by the continuous write judger 171 that writing has occurred continuously for two checkpoints, the DP counter adder 172 identifies the segment to which the page that was the target of that judgment belongs. The DP counter adder 172 then references the DP counter data 123 of the identified segment, and adds “1” to the value of the DP counter indicated by the referenced DP counter data 123. The DP counter adder 172 then sets the added value in the DP counter data 123 of the identified segment.

The transfer method setter 146 illustrated in FIG. 5 references the CP counter data, and at each specified period and based on the CP counter indicated by the CP counter data, selects for each segment the transfer method having the smallest expected value for the writing disabled time, and sets that method in the transfer method data 122 of the segment table data 120. The writing disabled time is the delay time from when a writing request occurs until writing is performed. As illustrated in FIG. 7, the transfer method setter 146 comprises a CP counter judger 181, a transfer method updater 182, a CP counter adder 183 and a CP counter clearer 184.

When it is presumed that the probability that a writing request will occur for a certain memory area during a transfer process is maintained, the expected value for the writing disabled time is the expected value for the writing disabled time for all memory areas. The expected value for the writing disabled time can simply be regarded for one transfer method to be proportional to the probability that writing will occur per unit time. The augmentation factor for the expected value for the writing disabled time with respect to the probability that a writing request will occur is greater in the COW transfer method than in the bulk copy transfer method, and when the probability that a writing request will occur is near “0”, the expected value for the writing disabled time in the COW transfer method is less than in the bulk copy transfer method. From this, when the probability that a writing request will occur exceeds a certain value, the small and large values of the expected value for the writing disabled time is reversed for the bulk copy transfer method and the COW transfer method.

The probability that a writing request will occur for a certain memory area during the transfer process is considered to be proportional to the writing frequency for a certain memory area. Therefore, in this embodiment, the probability that a writing request will occur can simply be represented by the DP counter that indicates the number of pages for which a writing request occurred continuously for two checkpoints (measurement periods). By set the transfer method based on the DP counter, a transfer method having a small expected value for the writing disabled time can be easily set. In this embodiment, when it is presumed that the writing frequency indicated by the DP counter is maintained, the expected value for the writing disabled time is the expected value of the total writing disabled time for the pages included in each segment.

The CP counter judger (transfer count judger) 181 references CP counter data that is stored in the main memory 104a. The CPU counter judger 181 determines whether or not the CP counter that is indicated by the referenced CP counter data is equal to or greater than a CP counter threshold value (CP threshold value).

When the CP counter judger 181 determines that the CP counter is equal to or greater than the CP threshold value, the transfer method updater 182 selects for each segment the transfer method having the smallest expected value for the writing disabled time based on the DP counter. The transfer method updater 182 then generates data that indicates the selected transfer method, and updates the transfer method by writing that data in the transfer method data 122 of the segment table data 120. As illustrated in FIG. 7, the transfer method updater 182 comprises a DP counter judger 185, a transfer method writer 186 and a DP counter clearer 187.

When the CP counter judger 181 determines that the CP counter is equal to or greater than the CP threshold value, the DP counter judger (writing occurrence judger) 185 references the DP counter data 123 of the segment table data 120. Then the DP counter judger 185 determines for each segment whether or not the DP counter that is indicated by the DP counter data 123 is equal to or greater than a DP counter threshold value (DP threshold value).

Based on the judgment result for each segment from the DP counter judger 185, the transfer method writer (transfer method generator) 186 selects the transfer method from among the bulk copy transfer method or the COW transfer method having the smallest expected value of the writing disabled time. The transfer method writer 186 writes data that indicates the selected transfer method to the main memory 104a as transfer method data 122. For example, when it is determined that the DP counter is equal to or greater than the DP threshold value, the transfer method writer 186 generates data indicating the bulk copy transfer method. On the other hand, when it is determined that the DP counter is less than the DP threshold value, the transfer method writer 186 generates data indicating the COW transfer method.

After the transfer method writer 186 writes the transfer method data 122, the DP counter clearer 187 sets the DP counter data 123 of the segment table data 120 to “0”.

When the CP counter adder 183 receives data from the CP monitor 141 indicating that a checkpoint has occurred, the CP counter adder 183 adds “1” to the CP counter that is indicated by the CP counter data stored in the main memory 104a, and sets the value after adding as the CP counter data.

After the transfer method writer 186 writes transfer method data 122 to the main memory 104a, the CP counter clearer 184 sets the CP counter data stored in the main memory 104a to “0”.

The write request judger 142 illustrated in FIG. 5 determines whether or not a write request to write to the main memory 104a occurred during execution of an application program or the like. When a write request has occurred, the write request judger 142 sends the data indicating the write request to the memory data updater 143.

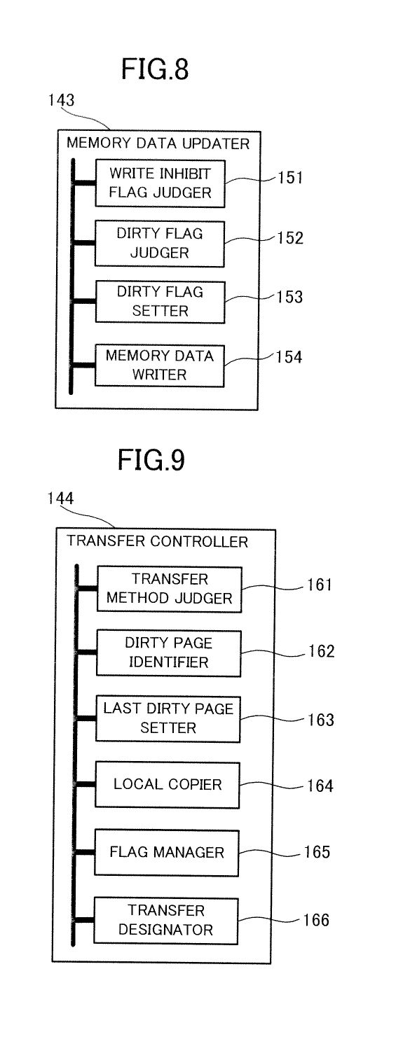

When the memory data updater 143 receives data from the write request judger 142 indicating a write request, the memory data updater 143 executes control and a writing process for writing to the memory data stored in the memory areas of the main memory 104a. FIG. 8 illustrates the detailed construction of the memory data updater 143. As illustrated in FIG. 8, the memory data updater 143 comprises a write inhibit flag judger 151, a dirty flag judger 152, a dirty flag setter 153 and a memory data writer 154.

The write inhibit flag judger 151 references the write inhibit flag data 114 of the page table data 110. According to that data, the write inhibit judger 151 determines whether or not writing to pages is inhibited.

The dirty flag judger 152 references dirty flag data 113 of the page table data 110. According to that data, the dirty flag judger 152 determines whether or not writing to a page occurred between the checkpoint and the previous checkpoint, or in other words, after the previous checkpoint.

When there was a write request, the dirty flag setter 153 sets the dirty flag data 113 so that a dirty flag is raised for the page for which there was a write request. More specifically, when there was a write request, the dirty flag setter 153 references the dirty flag data 113 and determines the state of the dirty flag correlated with the page for which there was a write request. When it is determined that the dirty flag is not raised, the dirty flag setter 153 sets the dirty flag indicated by that dirty flag data 113 to the raised state. As was described above, when the dirty flag is used as a counter, “1” is added to the dirty flag for the page for which there was a write request.

When the write inhibit flag judger 151 determines that writing to the page for which there was a write request is not inhibited, the memory data writer 154 writes the data.

When the transfer controller 144 illustrated in FIG. 5 receives data from the CP monitor 141 indicating that a checkpoint has occurred, the transfer controller 144 performs control for transferring the target transfer data to the second system 101b. As illustrated in FIG. 9, the transfer controller 144 comprises a transfer method judger 161, a dirty page identifier 162, a last dirty page setter 163, a local copier 164, a flag manager 165 and a transfer designator 166.

The transfer method judger 161 references the transfer method data 122 of the segment table data 120, and determines for each segment whether the transfer method correlated with the segment is the bulk copy transfer method or the COW transfer method.

The dirty page identifier (dirty unit identifier) 162 identifies dirty pages in the memory areas of the main memory 104a (104b). For example, the dirty page identifier 162 references the physical address data 111 or virtual address data 112 and the dirty flag data 113 of the page table data 110, and identifies pages for which the dirty flag is raised. Then, the dirty page identifier 162 identifies dirty pages by referencing the physical address data 111 or virtual address data 112 corresponding to pages for which the dirty flag is raised in the page table data 110.

Pages that are identified by the dirty page identifier 162 are areas whose contents are different than those of the second system 101b after the previous checkpoint. Therefore, pages that are identified by the dirty page identifier 162 are target transfer data. By the dirty page identifier 162 identifying dirty pages, it is possible to reduce the amount of data to be transferred more than in the case of transferring all memory data of target transfer areas.

When the dirty page identifier 162 identifies a dirty page, the last dirty page setter 163 stores the data that can identify that dirty page as last dirty page data 130.

The local copier 164 appropriately copies the target transfer data to the save area of the main memory 140a according to the transfer method determined by the transfer method judger 161. This local copy can be processed at high speed when the main controller 103a has a DMA function or mechanism.

The flag manager 165 references the dirty flag data 113 and the write inhibit flag data 114 of the page table data 110, determines the state of each flag, and appropriately performs an update.

The transfer designator 166, sends instruction data to the FT controller (transfer unit) 106a giving an instruction to transfer the target transfer data of each segment identified by the dirty page identifier 162 according to the transfer method determined by the transfer method judger 161. By transferring this kind of instruction data, the transfer designator 166 causes the FT controller 106a to transfer that memory data.

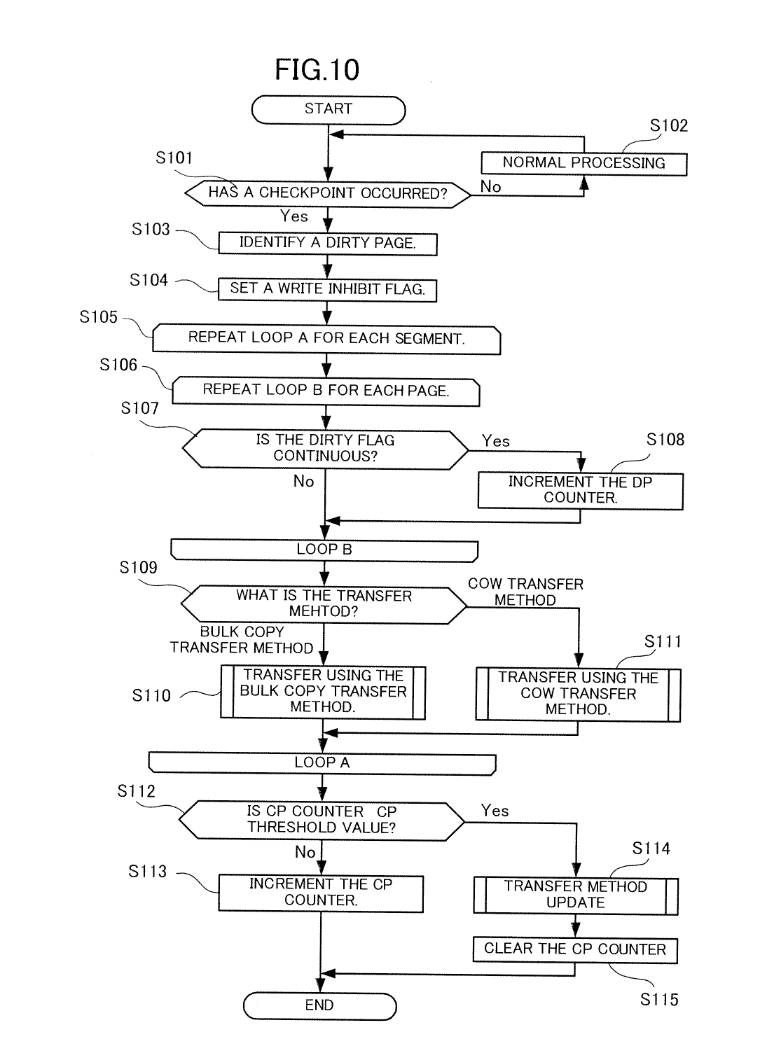

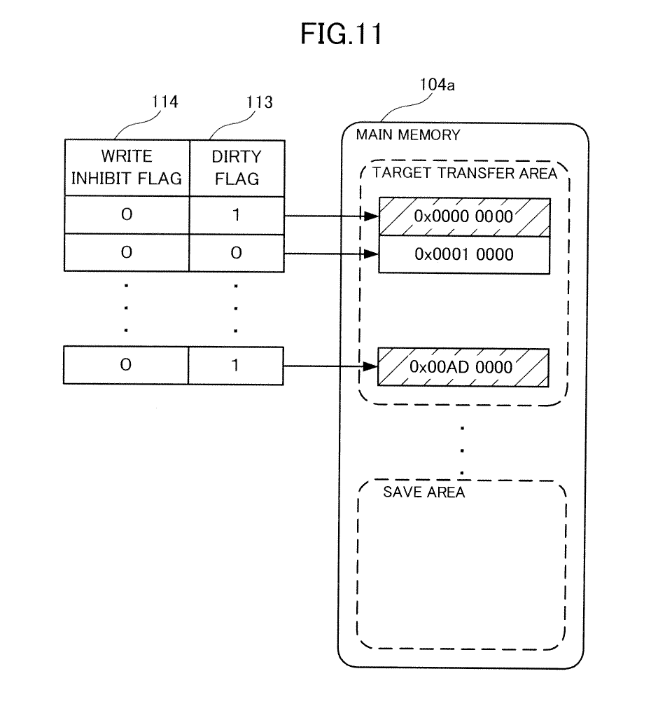

Up to this point, the construction of the FT server 100 of this embodiment has been explained. The processing that is executed by the first system 101a, which is the main system of the FT server 100 of this first embodiment, will be explained below with reference to FIGS. 10 to 25.

FIG. 10 is a flowchart illustrating the processing that is executed by the first system 101a of this first embodiment when a checkpoint occurs.

The CP monitor 141 determines whether or not a checkpoint has occurred (step S101). When it is determined that a checkpoint has not occurred (step S101: NO), the main controller 103a executes normal processing (step S102). Normal processing is processing is the execution of an OS, application software or the like.

When it is determined that a checkpoint has occurred (step S101: YES), the dirty page identifier 162 identifies dirty pages, which are pages for which writing occurred since the previous check point (step S103). For example, the dirty page identifier 162 references the dirty flag data 113 that is included in the page table data 110 that is stored in the main memory 104a. Then the dirty page identifier 162 determines for each page whether or not the dirty flag indicated by the reference dirty flag data 113 is raised. When it is determined that the dirty flag is raised, the dirty page identifier 162 identifies the page correlated with that dirty flag data 113 as a dirty page.

FIG. 11 schematically illustrates the state wherein memory data of a dirty page is identified in the dirty page identifying process (step S103). Target transfer data for that needs to be transferred when a checkpoint occurs is memory data of a dirty page. In the dirty page identifying process (step S103) it is possible to identify target transfer data.

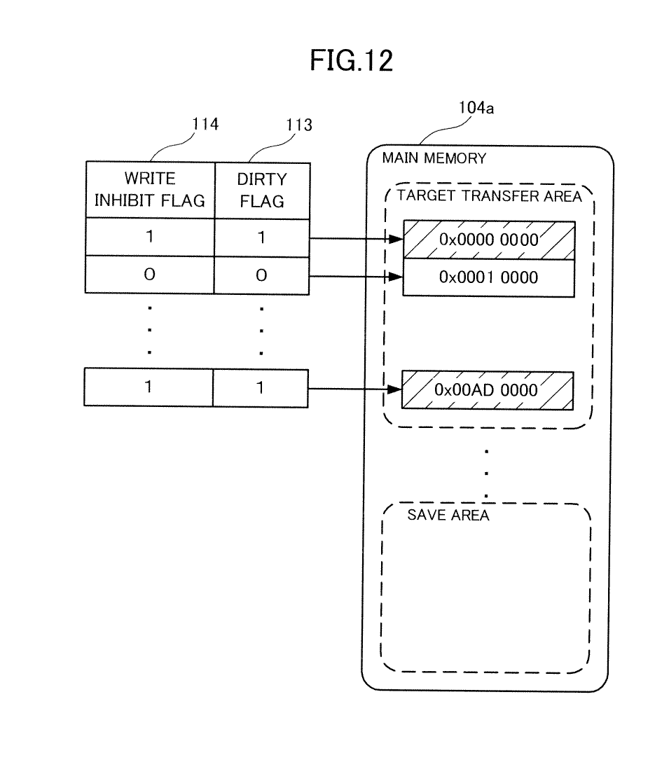

The flag manager 165 sets the write inhibit flag data 134 to “1” (step S104) for a dirty page that was identified in the dirty page identifying process (step S103). FIG. 12 schematically illustrates the state wherein the write inhibit flag is set in the write inhibit flag setting process (step S104). In the write inhibit flag setting process (step S104), writing to an area in the main memory 104a that corresponds to a dirty page is inhibited. Therefore, the contents of the memory data of a dirty page at a checkpoint are maintained.

The main controller 103a, repeats (step S105) for each segment the processing from the loop B process (step S106) to the COW method transfer process (step S111).

The DP counter calculator 145 repeatedly performs continuous dirty flag judgment processing (step S107) and DP counter addition processing (step S108) for each page in a segment that is a processing target (step S106).

The continuous write judger 171 determines whether or not a dirty flag for a page is continuously raised for two checkpoints (step S107). For example, the continuous write judger 171 references the last dirty page data 130 and the dirty flag data 113 of the page table data 110. The continuous write judger 171 identifies a page that is included in the last dirty page that is indicated by the last dirty page data 130 and for which a dirty flag that is indicated by the dirty flag data 113 is raised. The continuous write 171 then determines that a dirty flag was continuously raised for the identified page. Moreover, the continuous write judger 171 determines that a dirty flag is not continuously raised for pages other than that page.

When it was determined that a dirty flag was not continuously raised (step S107: NO), the continuous write judger 171 executes the continuous dirty flag judgment process (step S107) for the next page.

When it was determined that a dirty flag was continuously raised (step S107: YES), the DP counter adder 172 adds “1” to the DP counter that is correlated with the segment to which the page that is the target of judgment by the continuous write judger 171 belongs (step S108). For example, the DP counter adder 172 identifies the segment to which the page that is the target of judgment by the continuous write judger 171 belongs. Then, the DP counter adder 172 references the DP counter data 123 and acquires the DP counter for the identified segment. The DP counter adder 172 then adds “1” to the acquired DP counter, and writes data that indicates the value after adding to the main memory 104a as the DP counter data 123 of the segment table data 120.

By executing the processing in the loop B process (step S106) in this way, the number of pages for which a dirty flag is continuously raised for two checkpoints are counted for each segment. By counting the number of pages for each segment for which a dirty flag is raised that satisfies a specified condition in this way, it is possible to obtain an index that indicates whether or not the same pages in each segment are frequently updated based on history over a comparatively short period.

Continuing, referencing FIG. 10, the transfer method judger 161 determines the transfer method of the segment that is the target of processing (step S109). For example, the transfer method judger 161 references the transfer method data 122 of the segment table data 120 that is stored in the main memory 104a. The transfer method judger 161 then identifies the transfer method that is indicated by the referenced transfer method data 122, and by doing so, determines the transfer method to be used for the segment that is the target of processing. The transfer method in this embodiment is either the “bulk copy transfer method” or the “COW transfer method”.

When it is determined that the transfer method is the “bulk copy transfer method” (step S109: hulk copy transfer method), the transfer controller 144 performs control for transferring memory data of the dirty pages of the segment that is the target of processing to the second system 101b using the bulk copy transfer method, and the FT controller 106a transfers the memory data to the second system 101b (step S110).

The bulk copy transfer method will be explained below.

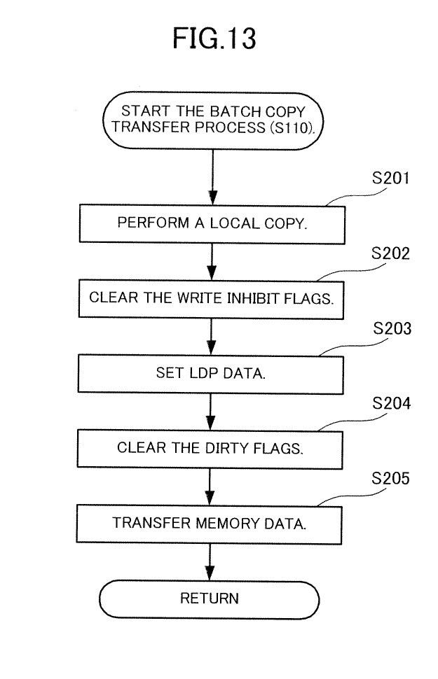

FIG. 13 is a flowchart illustrating the details of the bulk copy transfer process (step S110).

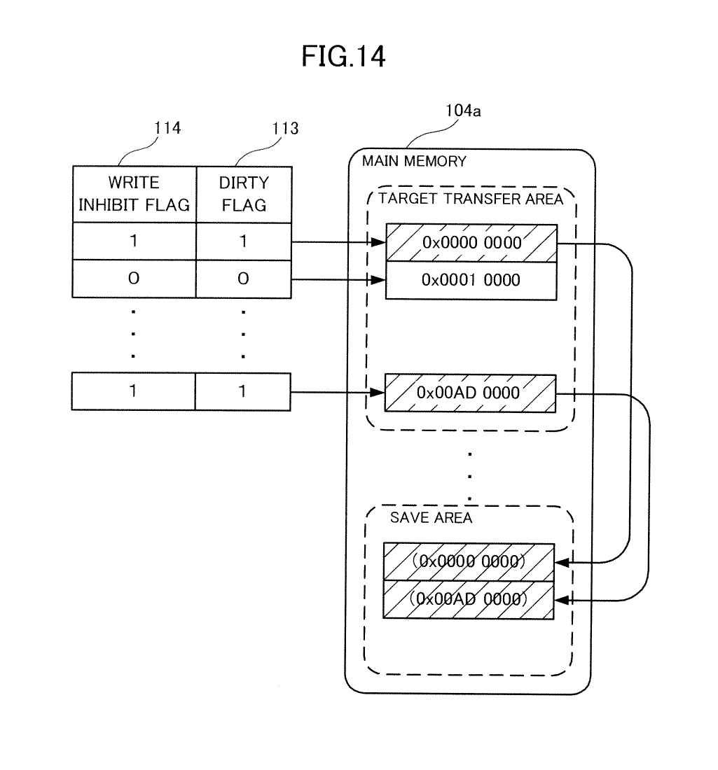

The local copier 164 performs a local copy of all of the memory data of dirty pages that were identified in the dirty page identifying process (step S103) (step S201). FIG. 14 schematically illustrates the state wherein all memory data of the dirty pages are locally copied. By executing the local copy process (step S201), the contents of memory data of a dirty page at a checkpoint are maintained.

In FIG. 14 “(0x0000 0000)” given in the parentheses in the save area indicates that memory data of the page starting from the physical address (given in hexadecimal notation) “0x0000 0000” is copied to the save area. The same is true for “(0x00AD 0000)”. This is the same in other figures as well.

The flag manager 165 clears the write inhibit flag that is correlated with a page for which the local copy process (step S201) has been completed (step S202). For example, the flag manager 165 sets the write inhibit flag data 134 that is correlated with a page for which the local copy process (step S201) has been completed to “0”. The flag manager 165 can clear the write inhibit flags that are correlated with all pages after all dirty pages have been copied, or can clear the inhibit flags that are correlated with the pages in order from the pages for which local copying has been completed. In the latter case, the total write disabled time for each page is reduced.

The last dirty page setter 163 causes data that can identify dirty pages identified in the dirty page identifying process (step S103) to be stored in the main memory 104a as LDP data (step S203). In doing so, last dirty page data 130 is set.

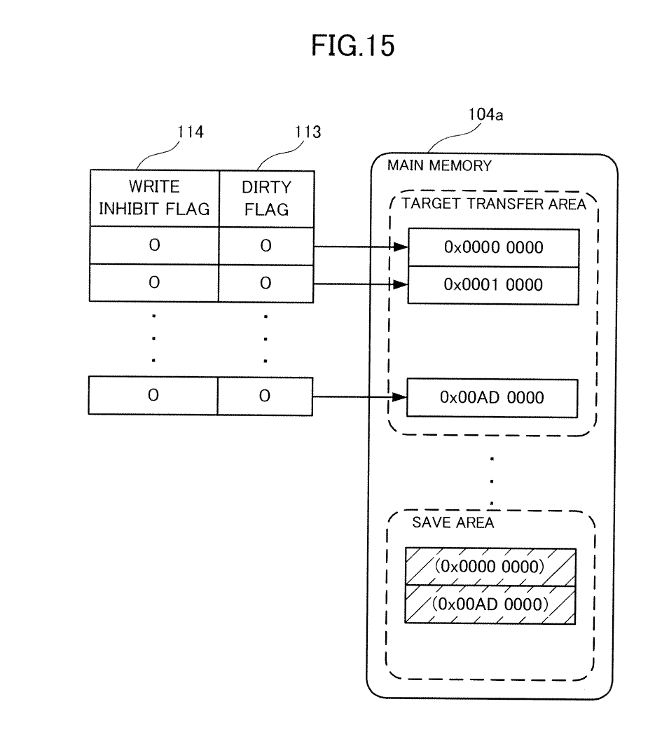

The flag manager 165 clears the dirty flags for all of the pages included in the segment that is the target of processing (step S204). For example, the flag manager 165 sets the dirty flag data 113 to “0” for all of the pages of the segment that is the target of processing. FIG. 15 schematically illustrates cleared dirty flags and write inhibit flags.

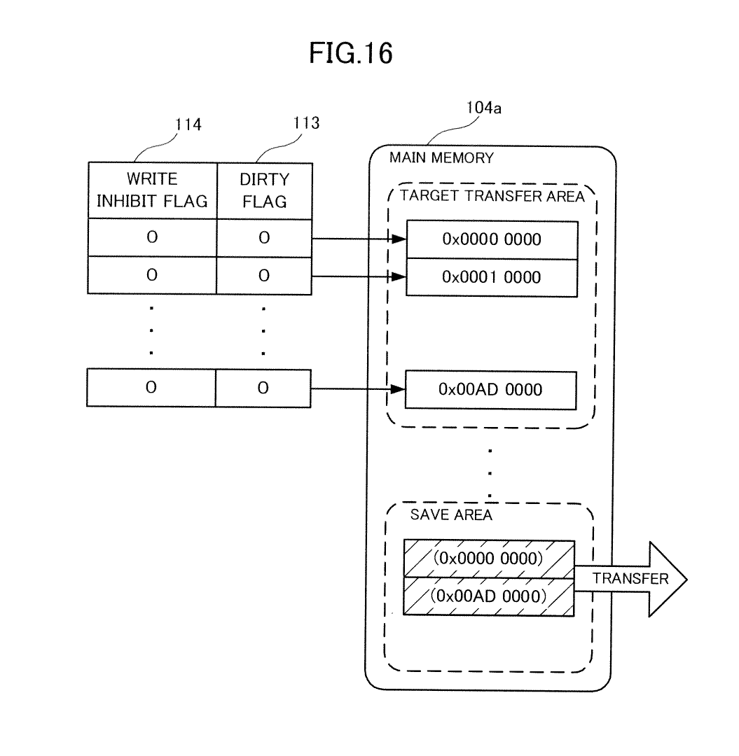

The transfer designator 166 causes the memory data of dirty pages that were copied to the save area to be transferred to the second system 101b (step S205). For example, the transfer designator 166 outputs instruction data to the FT controller 106a to transfer memory data of dirty pages that were copied to the save area to the second system 101b. The FT controller 106a receives the instruction data, then acquires and transfers the memory data to the second system 101b. FIG. 16 schematically illustrates, for the bulk copy transfer method, the state of the memory data of dirty pages being transferred.

This completes the transfer process (step S110) using the bulk transfer method. As a result, for the memory data of the segment that was the target of processing, the states of the main memories 104a, 104b of both systems 101a, 101b become the same.

Returning to FIG. 10, when the transfer method is determined to be the “COW transfer method” (step S109: COW transfer method), the transfer controller 144 performs control for transferring the memory data of dirty pages of the segment that is the target of processing to the second system 101b using the COW transfer method, and the FT controller 106a transfers the memory data to the second system 101b (step S111).

The COW transfer method will be explained below.

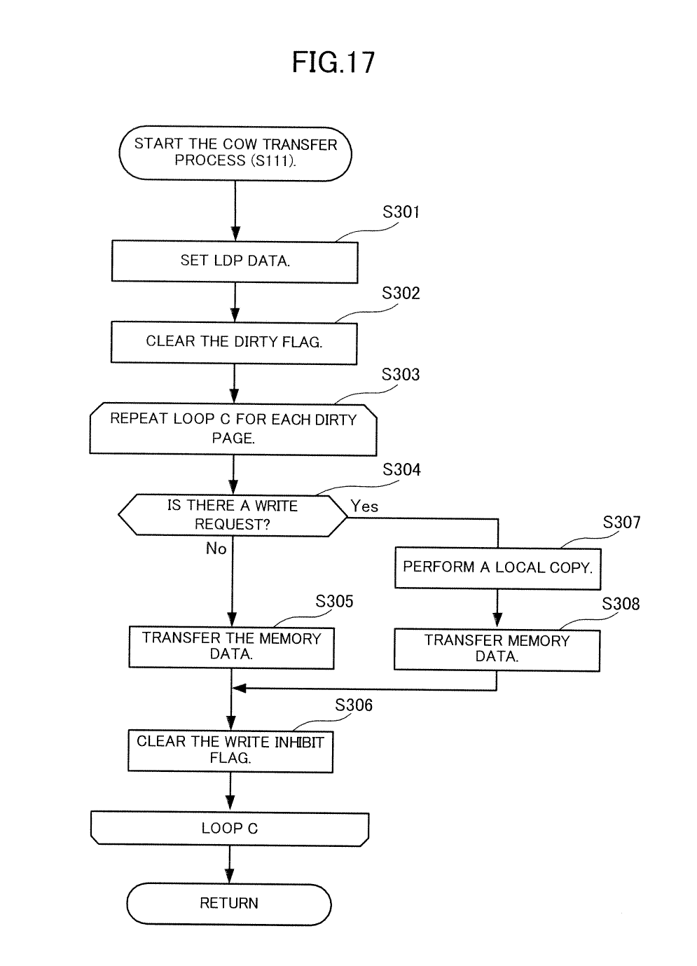

FIG. 17 is a flowchart illustrating the details of the COW transfer process (step S111).

The last dirty page setter 163, as in the LDP data setting process (step S203), causes data that can identify the dirty pages that were identified in the dirty page identifying process (step S103) to be stored in the main memory 104a as LDP data (step S301).

The flag manager 165, as in the dirty flag clearing process (step S204), clears the dirty flags of all of the pages that are included in the segment that is the target of processing (step S302).

The main controller 103a repeats the process from the write request judgment process (step S304) to the memory data transfer process (step S308) for each dirty page in the segment that is the target of processing (step S303).

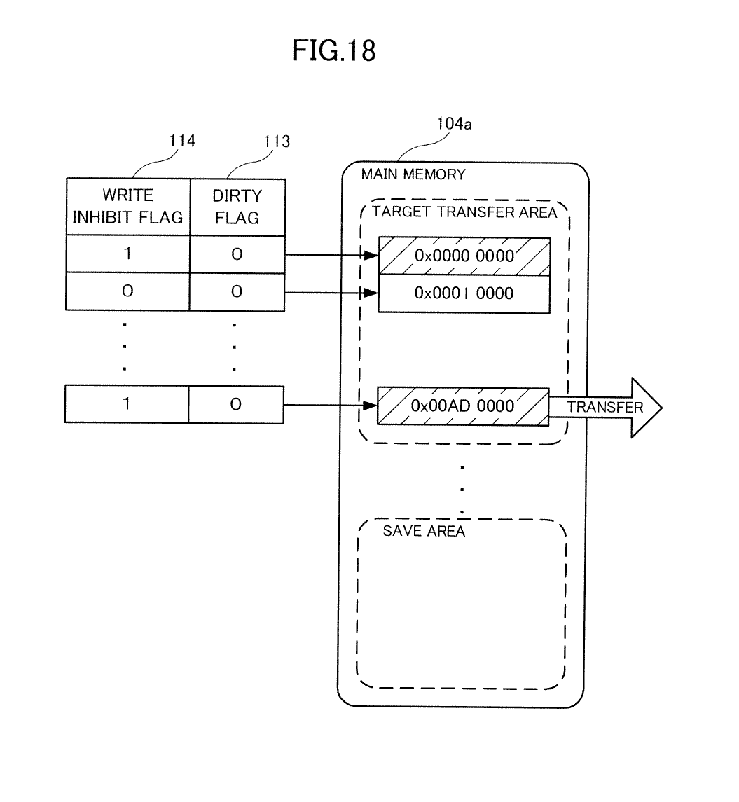

The write request judger 142 determines whether or not there is a write request for the dirty page that is the target of processing (step S304). When it is determined that there is no write request (step S304: NO), the transfer designator 166 outputs instruction data to the FT controller 106a to transfer the memory data of the dirty page that is the target of processing to the second system 101b (step S305). The FT controller 106a receives the instruction data from the transfer designator 166, and then according to that instruction, transfers the memory data to the second system 101b. FIG. 18 schematically illustrates the state of memory data of a dirty page being transferred when there is no write request.

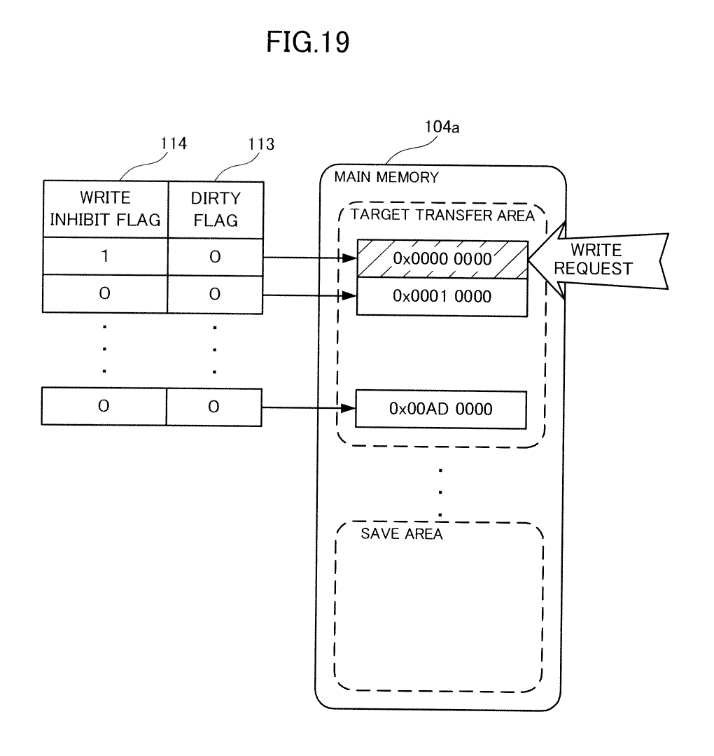

The flag manager 165 clears the write inhibit flag that is correlated with the page for which the memory data transfer process (step S305) has been completed (step S306). For example, the flag manager 165 sets the write inhibit flag data 134 that is correlated with the page for which the memory data transfer process (step S305) has been completed to “0” (refer to FIG. 19 for the state after update).

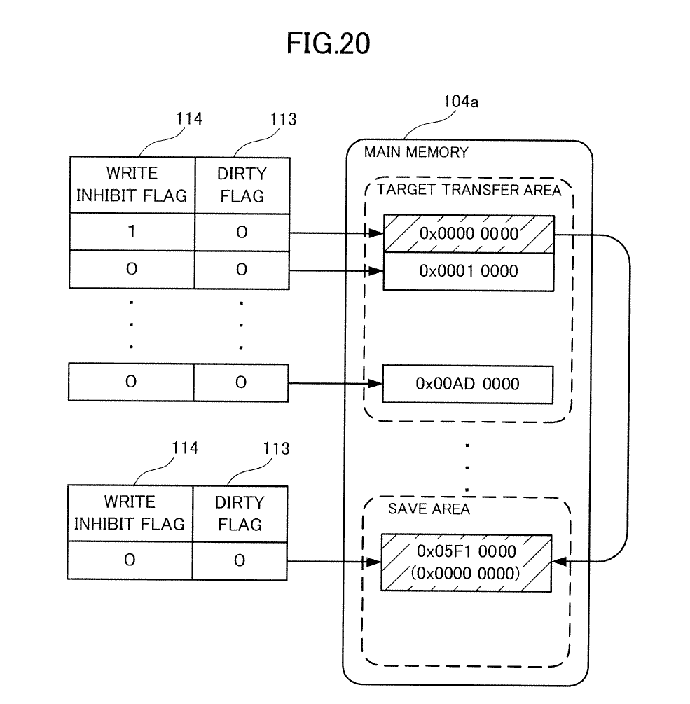

When it is determined that there is a write request (step S304: YES), the local copier 164 performs a local copy of the memory data of the dirty page that is the target of processing (step S307). FIG. 19 schematically illustrates the state wherein a write request occurred for a dirty page that has not been transferred. FIG. 20 schematically illustrates the state wherein memory data of a dirty page that has not been transferred and for which a write request occurred was locally copied. FIG. 20 illustrates that memory data of a page starting from the physical address (in hexadecimal notation) “0000 0000” is copied to a page in the save area that is identified by the physical address (in hexadecimal notation) “05F1 D100”.

The local copying process (step S307) is executed, for example, as an interrupt process in the first system 101a that executes a typical OS. Even when writing occurs for a dirty page that is the target of processing, by executing the local copying process (step S307), it is possible to maintain the contents of the memory data of the dirty page for which a write request occurred in the state as when the check point occurred.

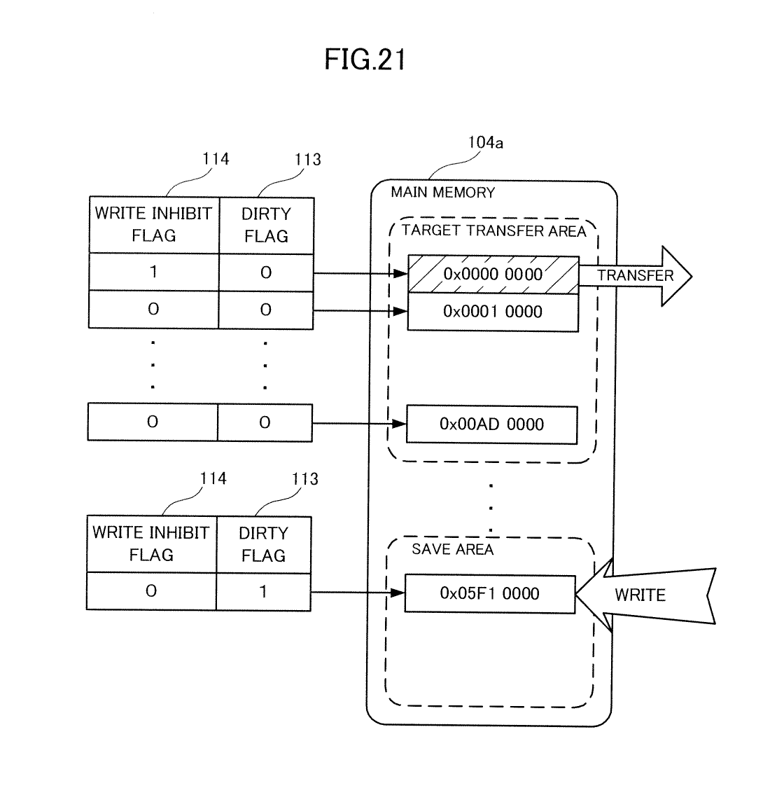

The transfer designator 166 outputs instruction data to the FT controller 106a in order to transfer the memory data of the dirty page that is the target of processing to the second system 101b (step S308). The FT controller 106a receives the instruction data from the transfer designator 166, and then according to that instruction, transfers the memory data of the dirty page to the second system 101b. FIG. 21 schematically illustrates the state of memory data of a dirty page for which a write request occurred being transferred. As illustrated in FIG. 21, the memory data to be transferred is the memory data of the local copy source. Writing is performed on the memory data of the local copy destination.

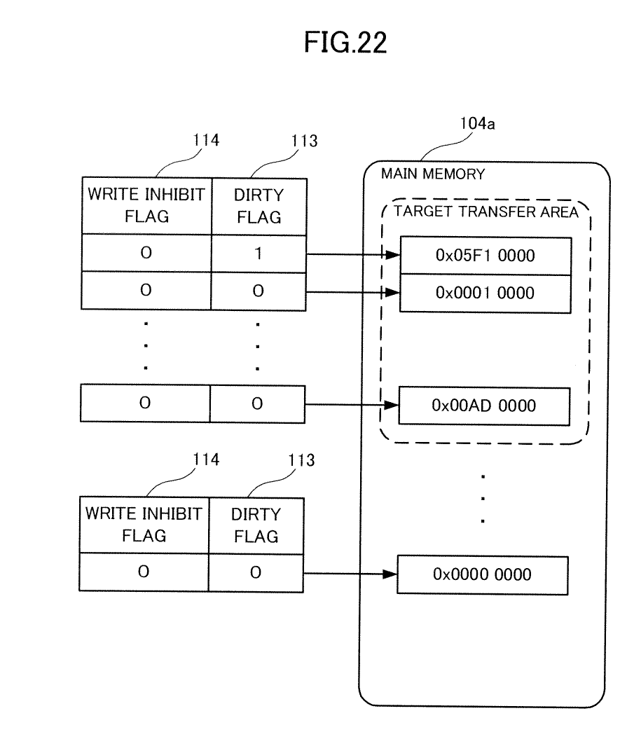

After the memory data transfer process (step S308) has been completed, the flag manager 165 clears the write inhibit flag of the dirty page for which transferring was completed (step S306). FIG. 22 schematically illustrates the state after memory data of a dirty page for which there was a write request has been transferred by the COW transfer method. As illustrated in FIG. 22, the write inhibit flag 114 that is correlated with the dirty page for which the transfer process of memory data has been completed is set to “0”. After the local copy process (step S307), writing is performed to the page of the local copy destination, and that page is put in the area that is the transfer target.

When writing is performed to memory data in the memory data update process, which will be described later, the flag manager 165 raises the dirty flag that is correlated to the page that includes the locally copied memory data. For example, the flag manager 165 sets the dirty flag data 113 that is correlated with that page to “1” (FIG. 21).

At this point the transfer process (step S111) by the COW transfer method is finished. As a result of this process, the state of the memory data of the segment that is the target of processing in the main memories 104a, 104b of both systems 101a, 101b is the same.

As explained up to this point, in the transfer process (step S110) by the bulk copy transfer method, the memory data for all of the dirty pages is locally copied together in the save area of the main memory 104a. On the other hand, in the transfer process (step S111) by the COW transfer method, memory data of dirty pages is transferred in order. When a write request occurs for a dirty page that has not yet been transferred, the memory data of that dirty page is locally copied to the save area of the main memory 104a. In other words, in the transfer process (step S111) by the COW transfer method, local coping does not occur when there is no writing to a dirty page that has not yet been transferred.

In the case of either the bulk copy transfer method or the COW transfer method, writing is disabled during local copying of a dirty page. The writing disabled time is a delay time from when a write request occurs until writing is performed, and includes overhead.

Therefore, in the case where few write requests occur during the transfer process, the expected value for the writing disabled time is less for the COW transfer method than for the bulk copy transfer method. However, when many write requests occur during the transfer process, the expected value for the writing disabled time is less for the bulk copy transfer method than for the COW transfer method.

Whether the expected value for the writing disabled times is less for the bulk copy transfer method or for the COW transfer method differs depending on whether there are many or few pages for which write requests occurred in a segment during the transfer process. In other words, when there are many pages for which a write requests occurred in a segment during the transfer process, the expected value for the writing disabled time is less for the bulk copy transfer method. When there are few pages for which a write requests occurred in a segment during the transfer process, the expected value for the writing disabled time is less for the COW transfer method. Therefore, the bulk copy transfer method or the COW transfer method is set according to whether there are many or few pages for which a write requests occurred in a segment during the transfer process.

There is a correlation between whether there are many or few pages for which a write request occurred during the transfer process and the frequency (writing frequency) of how many times writing to each segment occurred. That is, in the case of a segment for which the writing frequency is high, the probability that write requests occurred for many pages in that segment during the transfer process is high. On the other hand, in the case of a segment for which the writing frequency is low, the probability that write requests occurred for many pages in that segment during the transfer process is low. Therefore, by using the bulk copy transfer method for segments having a high writing frequency, and using the COW transfer method for segments having a low writing frequency, it is possible to shorten the writing disabled time when transferring memory data.

Moreover, a segment can be arbitrarily set; however, for example, when a segment is taken to be a small area such as a page unit, the amount of data necessary for data transfer such as the segment table data 120 becomes large. On the other hand, when a segment is taken to be a large area such as all of the target transfer data, the effect of shortening the writing disabled time by dynamically switching the transfer method becomes small. Therefore, preferably, a segment is set according to the access trend for accessing memory data. Typically, the access trend for accessing memory data largely depends on the application program being executed. Therefore, for example, a segment can be set according to the memory area in the main memory 104a that is used by the application program. By setting the transfer method for each segment in this way, it is possible to improve the effect of shortening the writing disabled time during each transfer, while at the same time suppress the amount of data necessary for data transfer.

Once again referencing FIG. 10, the CP counter judger 181 determines whether or not the checkpoint counter is equal to or greater than a CP threshold vale (step S112). For example, the CP counter judger 181 references the CP counter data stored in the main memory 104a. The CP counter judger 181 then performs judgment by comparing the CP counter indicated by the referenced CP counter data with a first threshold value.

When it is determined that the CP counter value is less than the first threshold value (step S112: NO), the CP counter adder 183 updates the CPU counter data in the main memory 104a with data that indicates the value after “1” has been added to the CP counter (step S113), then processing ends.

When it is determined that the CP counter value is equal to or greater than the first threshold value (step S112: YES), the transfer method updater 182 executes the transfer method update process (step S114). The transfer method update process (step S114) is executed every time that a checkpoint corresponding to the number of times set by the first threshold value passes. By appropriately setting the first threshold value, it is possible to adjust the load placed on the FT server 100 for executing the transfer method update process (step S114).

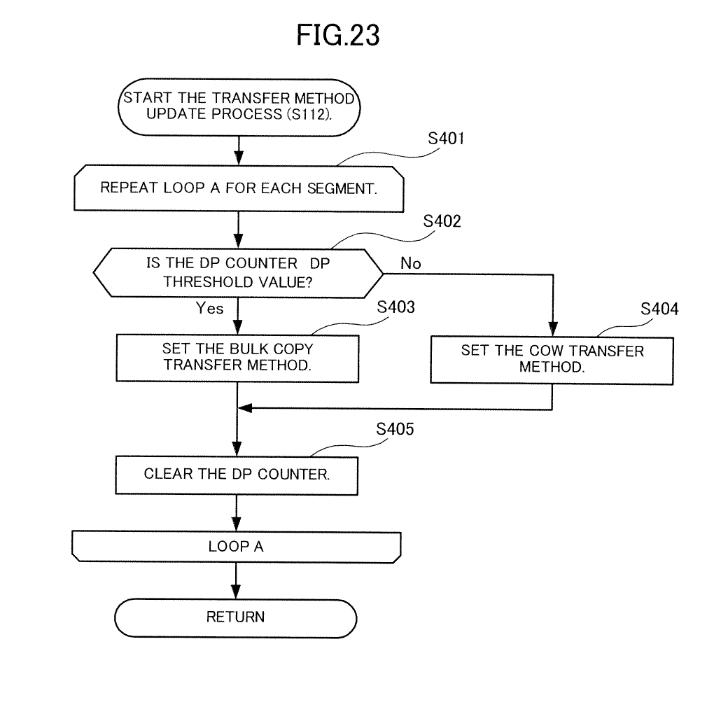

The transfer method update process (step S114) will be explained in detail with reference to FIG. 23.

The transfer method updater 182 repeats processing from the DP counter judgment process (step S402) to the DP counter clearing process (step S405) for each segment (step S401).

The DP counter judger 183 determines whether or not the DP counter of the segment that is the target of processing is equal to or greater than a second threshold value (step S402). For example, the DP counter judger 183 references the DP counter data 123 of the segment table data 120 that is stored in the main memory 104a. Then, the DP counter judger 183 identifies the DP counter of the segment that is the target of processing from among the DP counter indicated by the DP counter data 123 that is included in the referenced segment table data 120. Finally, the DP counter judger 183 compares the identified DP counter with the second threshold value and performs judgment based on the comparison results.

When it is determined that the DP counter is equal to or greater than the second threshold value (step S402: YES), the transfer method writer 184 sets the transfer method data 122 of the segment that is the target of processing to the “bulk copy transfer method” (step S403). For example, the transfer method writer 184 writes data to the main memory 104a indicating the “bulk copy transfer method” as the transfer method data 122 of the segment table data 120 that is correlated with the segment that is the target of processing.

When it is determined that the DP counter is less than the second threshold value (step S402: NO), the transfer method writer 184 sets the transfer method data 122 of the segment that is the target of process to the “COW transfer method” (step S405). For example, the transfer method writer 184 writes data to the main memory 104a indicating the “COW transfer method” as the transfer method data 122 of the segment table data 120 that is correlated with the segment that is the target of processing.

After the transfer method writer 184 has written the transfer method data 122, the DP counter clearer 186 clears the value of the DP counter 123 (step S405). For example, the DP counter clearer 186 writes data indicating “0” as the DP counter data 123 of the segment table data 120 that is correlated with the segment that is the target of processing.

As described above, the value of the DP counter indicates the frequency that updating is performed for pages in each segment during a specified counting period. Therefore, when the DP counter value is large, there is a high possibility that writing requests will occur for many pages during a transfer process using the COW transfer method, so performing transfer using the bulk copy transfer method is suitable. On the other hand, when the DP counter value is small, there is a low possibility that writing requests will occur for many pages during a transfer process even when transfer is performed using the COW transfer method, so that the COW transfer method is suitable. By applying the bulk copy transfer method for segments whose DP counter is equal to or greater than the second threshold value, and applying the COW transfer method for segments whose DP counter is less than the second threshold value, it is possible to shorten the writing disabled time when transferring memory data.

For example, the expected value for the writing disabled time can be calculated for both the bulk copy transfer method and the COW transfer method for when the DP counter value is increased in order from 1, and the DP counter value for which the size of the expected value for the writing disabled time is reversed can be set as the second threshold value.

Referencing FIG. 10 again, the CP counter clearer 184 clears the CP counter value (step S115), and processing ends. For example, the CP counter clearer 184 uses data indicating “0” to update the CP counter data that is stored in the main memory 104a.

In this way, when a checkpoint occurs, first, the dirty page identifying process (step S103) and the write inhibit flag setting process (step S104) are executed. As a result, the contents of memory data of dirty pages at a checkpoint are maintained. Next, the DP counter calculating process (step S106 to step S108) is executed. By doing so, the DP counter is calculated. Then, the memory data transfer process (step S109 to step S111) is executed. As a result, the main memory 104a and the main memory 104b are in the same state for the target transfer data. Furthermore, the transfer method setting process (step S112 to step S115) is executed. By doing so, the transfer method is updated to the method having the smallest expected value for the writing disabled time when transferring the memory data of each segment.

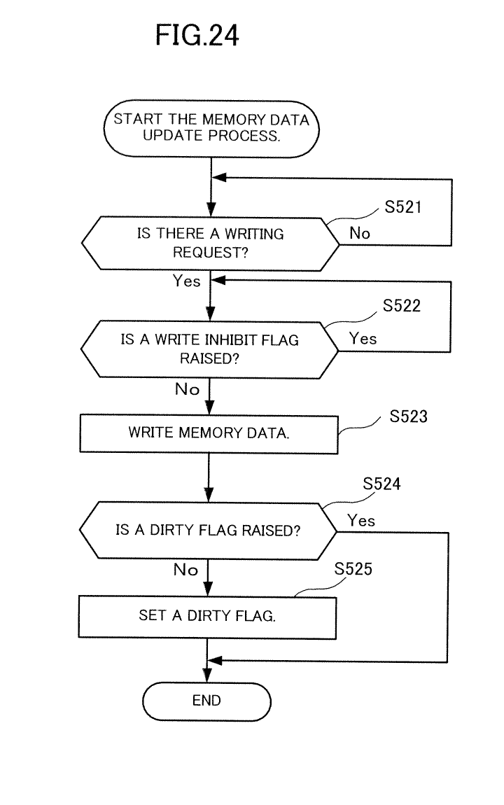

FIG. 24 is a flowchart illustrating the memory data update process that is executed by the first system 101a of this embodiment.

The write request judger 142 determines whether or not a write request to write to the main memory 104a has occurred (step S521). When it is determined that a write request has not occurred (step S521: NO), the write request judger 142 continues the write request judging process (step S521).

When it is determined that a write request did occur (step S521: YES), the write inhibit flag judger 151 determines whether or not the write inhibit flag is raised for the page for which the write request occurred (step S522). For example, the write inhibit flag judger 151 references the write inhibit flag data 114 of the page table data 110, and determines whether or not the write inhibit flag is raised based on the state of the write inhibit flag that is correlated with the page for which the write request occurred.

When it is determined that the write inhibit flag is raised (step S522: YES), the write inhibit flag judger 151 continues the write inhibit judgment process (step S522). When it is determined that the write inhibit flag is not raised (step S522: NO), the memory data writer 154 writes data related to that write request (step S523).

Next, the dirty flag judger 152 determines whether or not a dirty flag is raised for the page for which the write request occurred (step S524). For example, the dirty flag judger 152 references the dirty flag data 113 of the page table data 110, and determines whether or not a dirty flag is raised based on the state of the dirty flag that is correlated with the page for which the write request occurred.

When it is determined that a dirty flag is raised (step S524: YES), processing ends.

When it is determined that a dirty flag is not raised (step S524: NO), the dirty flag setter 153 sets “1” for the dirty flag data 113 in the page table data 110 that is correlated with the page for which the write request occurred (step S525), and processing ends. As a result, the dirty flag for the page that is to be written to is in the raised state.

By executing this kind of memory data update process, the memory data in the main memory 104a is updated. The dirty flag is also set for a page whose memory data was updated.

A first embodiment of the present invention was explained above.

With this embodiment, the segment table data 120 includes transfer method data 122 that sets the transfer method for each segment. In this embodiment, the transfer method that is set is either the bulk copy transfer method or the COW transfer method. The bulk copy transfer method is a transfer method that can transfer data with a shorter writing disabled time than the COW transfer method when the frequency of writing requests during the transfer process is high. The COW transfer method is a transfer method that can transfer data with a shorter writing disabled time than the bulk copy transfer method when the frequency of writing requests during the transfer process is low.

In the transfer method data 122, either the bulk copy transfer method or the COW transfer method is set for each segment according to the frequency that writing requests occur in a segment. Therefore, by referencing the transfer method data 122 and transferring memory data of each segment according to the transfer method that is set for each segment, it is possible to transfer the memory data of each segment with a short writing disabled time. In this embodiment, an area that is the target of transferring data is divided into a plurality of segments, so it is possible to shorten the writing disabled time more than when transferring all of the memory data of a target transfer area using the same transfer method.

Moreover, with this embodiment, the transfer method for each segment that is indicated by the transfer method data 122 is set based on a DP counter that is indicated by the DP counter data 123. When the DP counter is equal to or greater than a DP threshold value, the bulk copy transfer method is set, and when the DP counter is less than a DP threshold value, the COW transfer method is set. As was explained for this embodiment, the DP counter indicates the frequency that writing occurs for each segment, and is correlated with the probability that writing requests will occur for each segment during the transfer process. Therefore, by setting the transfer method according to the DP counter, it is possible to easily set the transfer method having a small expected value for the writing disabled time.

Furthermore, with this embodiment, the DP counter is calculated based on the dirty flag data 113 of the page table data 110 and the last dirty page data 130. The page table data 110 of this embodiment is data that is normally stored by the main controller 103a when managing the memory area of the main memory 104a in page units. Therefore, the DP counter can easily be expressed by storing last dirty page data 130 in the main memory 104a.

Moreover, with this embodiment, when the CP counter that is indicated by the CP counter data is equal to or greater than a CP threshold value, the setting for the transfer method for each segment that is indicated by the transfer method data 122 is updated. As a result, rather than updating the transfer method setting each time a checkpoint occurs, it is possible to review the transfer method at suitable timing, while at the same time suppress the processing load placed on the FT server 100. There is a possibility that the access trend for accessing memory data of each segment could change at any time; however, with this embodiment, the update timing for setting the transfer method can be set arbitrarily, so it is possible to maintain the effect of a short writing disabled time.

Furthermore, in this embodiment, the main memory 104a stores segment table data 120 and last dirty page data 130. This can easily be achieved by typical or expanded OS functions. Also, in this embodiment, local copying in the COW transfer method when a write request occurs can be easily achieved by a typical or expanded OS interrupt function.

### Embodiment 2

In a second embodiment of the present invention, the cache of the main memory stores data corresponding to the segment table data 120 and last dirty page data 130 in the first embodiment. This point differs from the first embodiment in which both of these data 120 and 130 are stored in the main memory 104a. By storing these data 120, 130 in the cache, it is possible to achieve part of the functions achieved by the software in the first embodiment by the hardware. Therefore, in this embodiment, in addition to the effect of the first embodiment, it is possible to perform processing at higher speed.

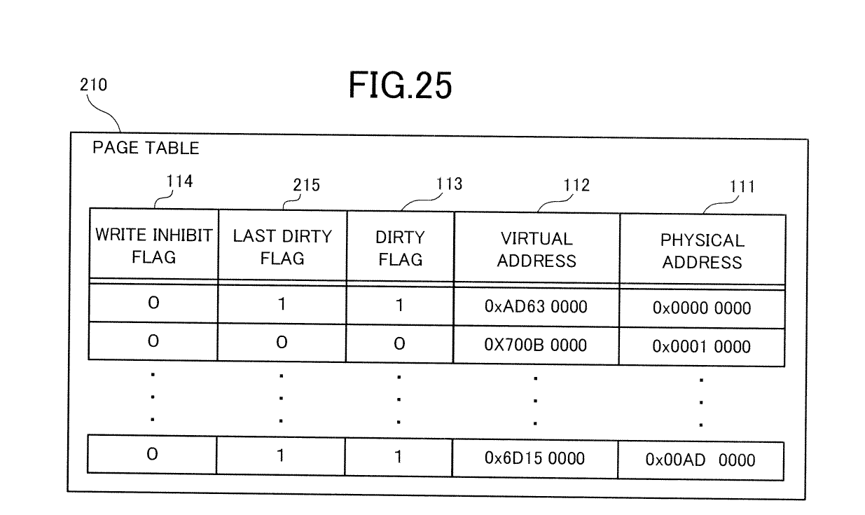

This second embodiment will be explained with reference to FIG. 25 to FIG. 31. In these figures, the same reference numbers will be used for component elements that are the same as in the first embodiment, and any redundant explanations of component elements that are the same as in the first embodiment are omitted.

The construction of the FT server of this second embodiment of the present invention is the same as that of the FT server 100 illustrated in FIG. 1.

The detailed construction of the main controller, and the data that are stored in the main memory and the cache differ from that of the first embodiment.

First, the cache of this embodiment stores segment table data 120 (FIG. 3) that is the same as that of the first embodiment, and page table data 210 as illustrated in FIG. 25.

As illustrated in FIG. 25, in addition to the data 111 to 114 included in the page table data 110 of the first embodiment, the page table data 210 of this embodiment includes last dirty flag data 215 that is correlated for each page.

The last dirty flag data 215 is data that indicates the state of the last dirty page flag. When the page that the last dirty flag data 215 is correlated with is a last dirty page, the last dirty page flag is “1”, which indicates the raised state. When the page that the last dirty flag data 215 is correlated with is not a last dirty page, the last dirty page flag is “0”, which indicates the non-raised state.

In other words, the last data flag data 215 corresponds to data (LDP data) for identifying the last dirty page.

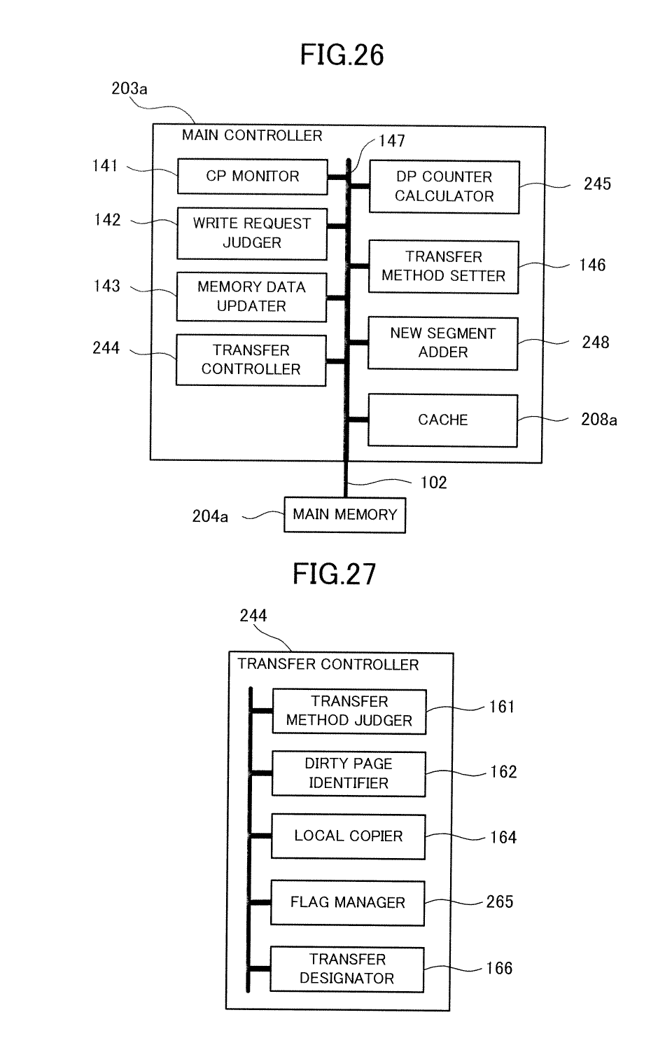

As illustrated in FIG. 26, the main controller 203a of this embodiment, in addition to construction comprising the main controller 103a (FIG. 5), also comprises a new segment adder 248. Moreover, the main controller 203a, instead of the transfer controller 144 and the DP counter calculator 145 of the first embodiment, comprises a transfer controller 244 and DP counter calculator 245.

The transfer controller 244 performs control for transferring memory data in the same way as the transfer controller 144 of the first embodiment. The transfer controller 244, as illustrated in FIG. 27, comprises a flag manager 265 instead of the flag manager 165. The transfer controller 244 does not comprise a last dirty page setter 163 (FIG. 9).

The flag manager 265 references last dirty flag data 215 in addition to the dirty flag data 113 and write inhibit flag data 114 of the page table data 110, determines the status of each flag, and appropriately updates the data. In this way, in this embodiment, the flag manager 265 manages data that corresponds to the LDP data. Therefore, the flag manager 265 differs from the flag manager 165 of the first embodiment in that it accesses only the cache 208a and does not access the main memory 204a. As a result, the flag manager 265 can perform processing faster than the flag manager 165.

The DP counter calculator 245 illustrated in FIG. 26, having the same construction as the DP counter calculator 145 of the first embodiment, calculates the DP counter and updates the DP counter data 123 of the segment table data 120 according to the calculated value. The continuous write judger 271 of the DP counter calculator 245 is the same as the continuous write judger 171 of the DP counter calculator 145 of the first embodiment, and determines for each page whether or not writing occurred continuously for two checkpoints. However, the continuous write judger 271 differs from the continuous write judger 171 in that it references the dirty flag data 113 and the last dirty flag data 215 of the page table data 210. When both of the flags indicated by the referenced data 113 and 215 are raised, the continuous write judger 271 determines that writing has occurred continuously for two checkpoints. Otherwise, the continuous write judger 271 determines that writing did not occur continuously for two checkpoints.

Returning to FIG. 26, the new segment adder 248 adds new segment entries to the segment table data 120.

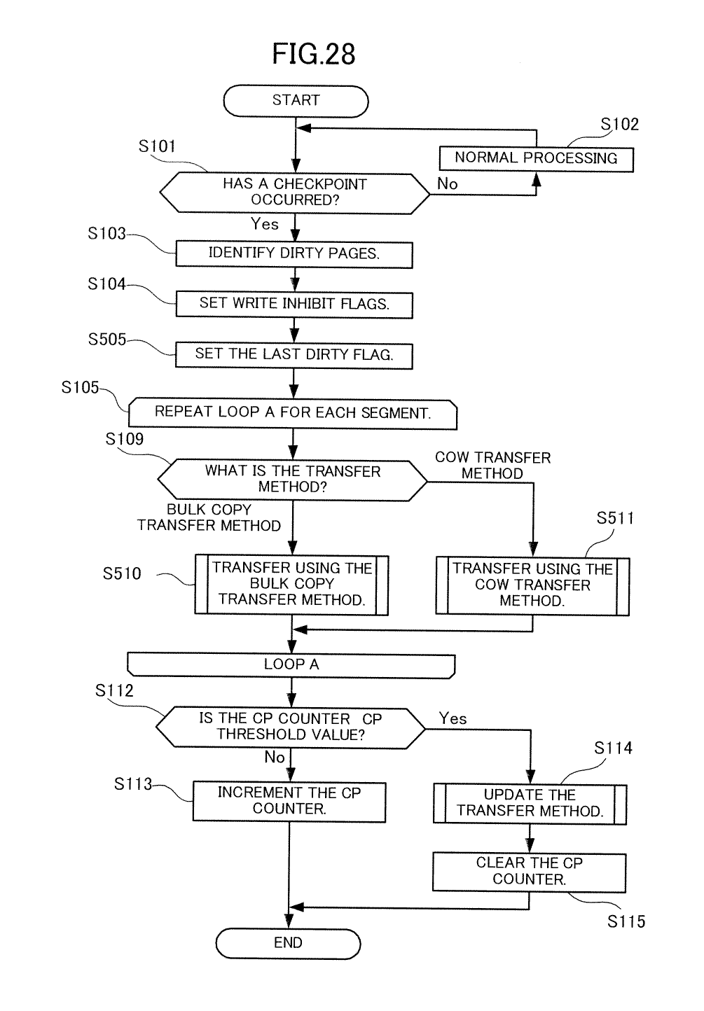

Up to this point, the construction of the FT server 200 of this embodiment was explained. Processing that is executed by the first system, which is the main system of the FT server 200 of this embodiment, will be explained with reference to FIG. 28 to FIG. 32.

FIG. 28 is a flowchart illustrating the processing that is executed by the first system of this second embodiment when a checkpoint occurs. As illustrated in FIG. 28, in this second embodiment, differing from the first embodiment (FIG. 10), after the dirty page identifying process (step S103) and write inhibit flag setting process (step S104) have been executed, a last dirty flag setting process (step S505) is executed. Moreover, in this flowchart, the DP counter calculation process (step S106 to step S108) is not executed. This is because in this embodiment, the DP counter calculation process is executed when a write request occurs and not when a checkpoint occurs. The DP counter calculation process of this embodiment will be explained in detail later.

In the last dirty flag setting process (step S505), the flag manager 264 first, sets the last dirty flag data 215 for all pages to “0”. As a result, last dirty flags for all pages are cleared. Then, the flag manager 264 moves the state of the dirty flag of each page as indicated by the dirty flag 113 as is to the last dirty flag data 215. By doing so, the dirty flags are cleared and the last dirty flags are set. This corresponds to the last dirty page setting process (step S203 or step S301) and the dirty flag clearing process (step S204 or step S302) of the first embodiment. The last dirty flag setting process (step S505) of this embodiment moves data in the cache 208a such as TLB for example. Therefore, with this embodiment, processing corresponding to the last dirty page setting process (step S203 or step S301) and the dirty flag clearing process (step S204 or step S302) can be executed faster than in the first embodiment.

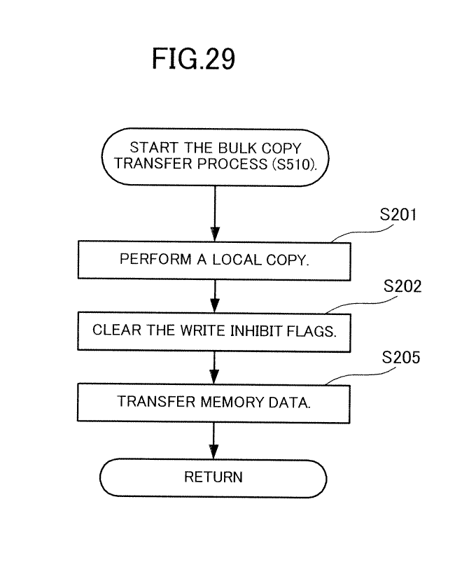

Moreover, in this embodiment, details of the hulk copy transfer process (step S510) illustrated in FIG. 28 differ from the bulk copy transfer process (step S110 in FIG. 10) of the first embodiment. FIG. 29 illustrates the details of the bulk copy transfer process (step S510) of this embodiment. As illustrated in FIG. 29, the bulk copy transfer process of this embodiment (step S510) differs from the bulk copy transfer process of the first embodiment (step S110)(FIG. 13) in that the last dirty page setting process (step S203) is not executed. The dirty flag clearing process (step S204) is also not executed.

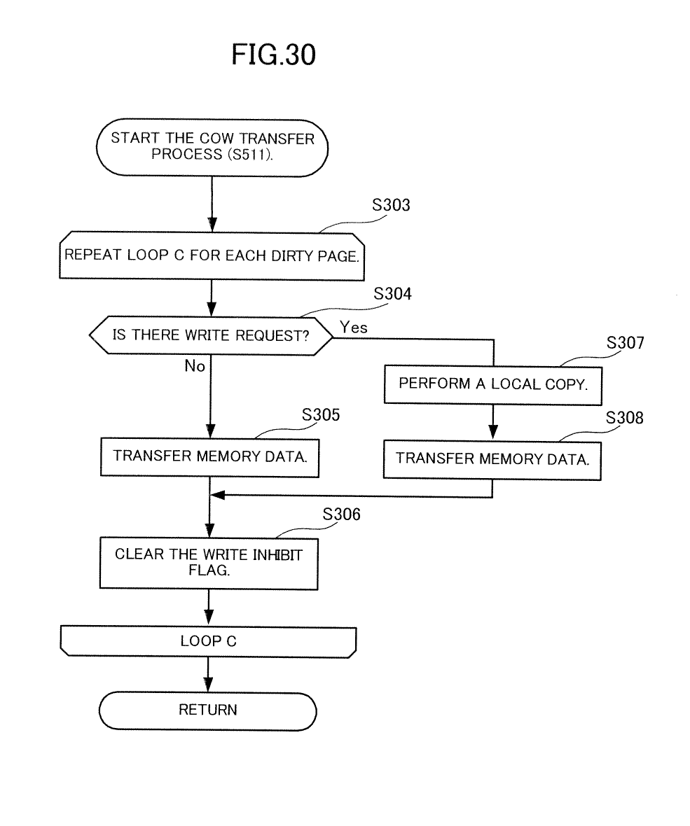

Furthermore, in this embodiment, details of the COW transfer process (step S511) illustrated in FIG. 28 differ from the COW transfer process (step S111 in FIG. 10) of the first embodiment. FIG. 30 illustrates the details of the COW transfer process (step S511) of this embodiment. As illustrated in FIG. 30, the COW transfer process of this embodiment (step S511) differs from the COW transfer process of the first embodiment (step S111) (FIG. 17) in that the last dirty page setting process (step S301) is not executed. The dirty flag clearing process (step S302) is also not executed.

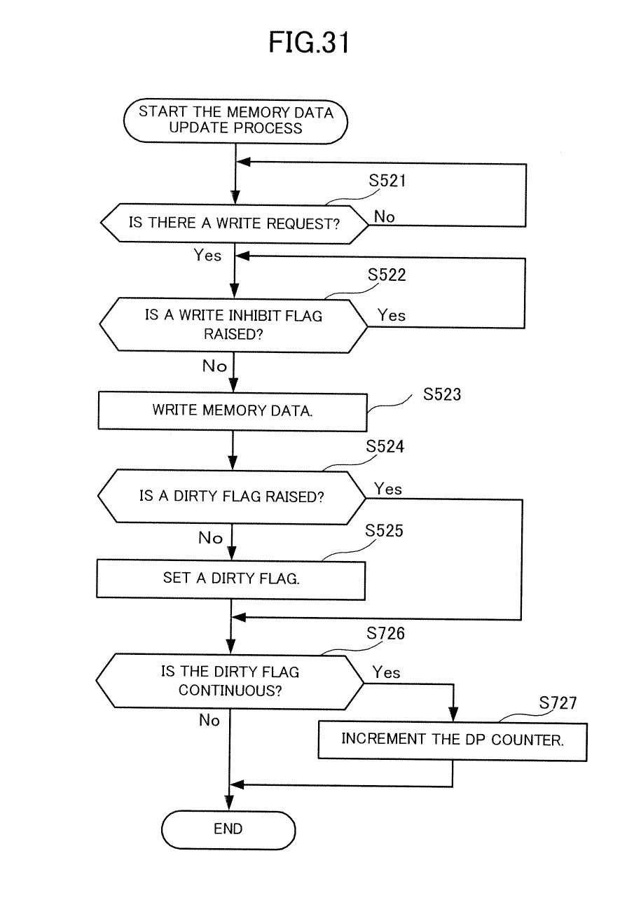

FIG. 31 is a flowchart illustrating the memory data update process that is executed by the first system of this embodiment. As illustrated in FIG. 31, the memory data update process of this embodiment includes a continuous dirty flag judgment process (step S726) and a DP counter addition process (step S727) in addition to the memory data update process (FIG. 24) of the first embodiment. The additional processes (step S726 and step S727) in the memory data update process of this embodiment correspond to the DP counter calculation process (step S106 to step S108 in FIG. 10) of the first embodiment.

After the dirty flag setting process (step S525), the continuous write judger 271 determines for each page whether or not writing occurred continuously for two checkpoints (step S726). For example, the continuous write judger 271 references the dirty flag data 113 and the last dirty flag data 215 in the page table data 210 for which write requests occurred. The continuous write judger 271 performs judgment according to the state of the flags indicated by the reference data 113 and 215.

When either one or both of the flags indicated by referenced data 113 and 215 are not raised, the continuous write judger 271 determines that specified writing did not occur (step S726: NO), and processing ends.

When both of the flags indicated by the referenced data 113 and 215 are raised, the continuous write judger 271 determines that specified writing occurred (step S726: YES). In that case, the DP counter calculator 245 adds 1 to the DP counter that is correlated with the segment to which the page that is the target of judgment by the continuous write judger 271 belongs (step S727), and ends processing.

In the memory data update process of this embodiment, or in other word, when a write request occurred, the DP counter calculation process (step S726 and step S727) is executed. As a result, the processing that is executed when a checkpoint occurs is less than that executed in the first embodiment, and thus the processing load is reduced.

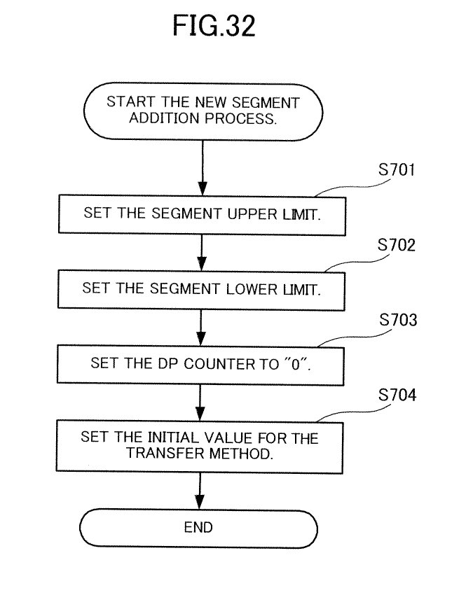

Furthermore, FIG. 32 is a flowchart illustrating the new segment addition process that is executed by the first system of this embodiment.

The new segment adder 248 sets the upper limit for the physical address of a new segment in the segment upper limit data 125 of the segment table data 120 (step S701). The new segment adder 248 sets the lower limit for the physical address of a new segment in the segment lower limit data 124 of the segment table data 120 (step S702). The new segment adder 248 sets the DP counter data 123 of a new segment in the segment table data 120 to “0” (step S703). The new segment adder 248 sets the initial value for the transfer method data 122 of a new segment in the segment table data 120 (step S704), and ends processing. Either the bulk copy transfer method or the COW transfer method is preset for the initial value.

Through this kind of new segment addition process, a new segment entry is added to the segment table data 120.

A second embodiment of the present invention was explained above.

With this embodiment, as in the first embodiment, it is possible to transfer the memory data of the entire target transfer area with a shorter writing disabled time than when performing transferring with only one transfer method.

Moreover, as in the first embodiment, the target transfer ea is divided into a plurality of segments, so that it becomes possible to shorten the writing disabled time more than when the memory data for the entire target transfer area is transferred with only one transfer method.

Also, as in the first embodiment, by setting the transfer method based on the DP counter, it becomes possible to easily set the transfer method to the method having the smallest expected value for the writing disabled time.

Furthermore, the DP counter can easily be achieved by storing last dirty page data 130 in the cache 208a.

Moreover, as in the first embodiment, it is possible to arbitrarily set the timing for updating the setting for the transfer method, so that it becomes possible to continue the effect of shortening the writing disabled time.

In this embodiment, the cache 208a stores the segment table data 120 and the last dirty flag data 215. The main controller 103a can typically access the cache 208a faster than accessing the main memory 204a. Therefore, it is becomes possible to increase the speed of processing for accessing these data 120 and 215. Consequently, with this embodiment, it is particularly possible to increase the speed of processing that is executed when a checkpoint occurs.

Furthermore, additionally including the segment table data 120 and last dirty flag data 215 in the TLB can be achieved by changing the micro code in the case where the processer for the main controller 103a comprises a counter. Therefore, by employing this embodiment in this kind of case, it is particularly easy to achieve efficient transfer of memory data.

Embodiments of the present invention have been explained; however, the present invention is not limited to the embodiments explained above.

For example, the embodiments of the present invention can also be applied to the case of implementing redundant configuration in the virtual environment of the CPU of a virtual OS support mechanism. For example, the CPU can also store a segment table together with adding a last dirty flag to the page table stored by the CPU. In this case as well, high-speed processing becomes possible by supporting the hardware configuration.

Moreover, for example, in each of the embodiments above it was presumed that the target transfer data is data in the main memory 104a; however, the target transfer data is not limited to this. The target transfer data can be arbitrary data that is transferred to another system or device. Moreover, the target transfer data can be arbitrary data that is transferred within the same device. The area that stores the target transfer data is the target transfer area. The target transfer area is not limited to the main memory 104a (104b), and can be set in a memory area of an arbitrary memory of the FT server.

Furthermore, for example, in the embodiments above an example was explained of an FT server 100 (200) that comprises two systems 101a, 101b (201a, 201b); however, the FT server is not limited to this. The FT server could also comprise three or more systems. Even in the case of the FT server comprising 3 or more servers, during normal operation, one of the systems functions as the main system, and the others wait in standby. The systems that wait in standby maintain the same state as the main system.

Moreover, for example, the transfer unit in the embodiments above is a page; however, the transfer unit is not limited to this. The transfer unit can be set to an arbitrary size.

Furthermore, for example, in each of the embodiments, page table data is stored as transfer unit table data, and data indicating the physical address that is the start of each page is stored as physical address data; however, the physical address data is not limited to this. As long as the physical address data is data that can identify each page, the physical address data could be data that indicates the physical addresses that will be the upper limit and lower limit of each transfer unit. Moreover, a virtual address data can be data that indicates the virtual addresses that will be the upper limit and lower limit of each transfer unit. Furthermore, as another example of data that can identify each page, is data that indicates a page number that is assigned to each page.

Furthermore, for example, in each of the embodiments, the dirty flag data 113 identified dirty pages by using a flag that was either “1” or “0”; however the dirty flag data 113 is not limited to this. As long as the dirty flag data 113 is data that can identify a dirty page, it does not have to be indicated by a flag. Moreover, even when a flag is used, the flag status can be indicated by any arbitrary characters or symbols other than “0” and “1”. This is the same for the write inhibit flag data 114 and the last dirty flag data 215.

Moreover, for example, in each of the embodiments, the transfer period and the counter calculation period were both the same checkpoint; however, the transfer period and the counter calculating period are not limited to this. The transfer period can be arbitrarily set as the period for starting the transfer process. Also, the counter calculation period can be arbitrarily set as the start of the DP counter calculation process. However, when the transfer period and the counter calculation period are different, data that indicates dirty pages when the transfer period occurs, and data that indicates dirty pages when the counter calculation period occurs are both needed. Each respective data can be included in page table data 110, 120 in the place of dirty flag data 113, for example.

Furthermore, for example, in each of the embodiment, the transfer methods used were the bulk copy transfer method and the COW transfer method; however, the transfer method is not limited to these. For example, the transfer method can be a method such that each time when writing occurs in the target transfer area, the written contents are written to the save area, and when a checkpoint occurs, the memory data in the save area is transferred. This method can be used to efficiently transfer memory data when applied to segments for which there are few write requests, and particularly when applied to segments for which writing is not concentrated to a certain page.

Moreover, for example, in each of the embodiments, a specified condition for calculating the frequency of the occurrence of writing to each segment was that a dirty flag was raised continuously for two checkpoints; however, the specified condition is not limited to this. For example, the specified condition could be when writing occurred after the previous checkpoint. The specified condition could also be when a dirty flag was raised one time at a certain checkpoint. In that case, for example, the DP counter is the value of the total number of pages in each segment for which a dirty flag indicated by the dirty flag data 113 was raised at each checkpoint. Furthermore, the specified condition could be when a dirty flag occurred continuously for a specified number of checkpoints that is three or more. In that case, for example, the DP counter is a value that is the total number of pages for each segment for which a dirty flag was raised continuously for three or more checkpoints. As was described above, a dirty flag can be a counter that indicates the number of times writing occurred during a specified period. In that case, the DP counter, for example, is the totaled dirty flag value for each segment.

Moreover, for example, in each of the embodiments, the transfer method was set according to the frequency of writing to each segment; however, the index for setting the transfer method is not limited to the writing frequency. The transfer method should be set based on a value according to the probability that writing will occur in a segment that is being transferred (writing occurrence). In other words, writing frequency and frequency data that indicates that frequency are examples of writing occurrence and occurrence data that indicates the occurrence, respectively.

In addition to the frequency of the occurrence of writing in each segment (writing frequency) the writing occurrence includes, for example, the probability or ratio that writing occurred in each segment (writing probability or writing ratio). The writing occurrence can be a value that is proportional to (correlated with) other writing occurrence probability or ratio. It is possible to set a number of monitor areas having a set size in each segment in advance according to the size of the segment, and by digitizing whether or not writing occurred in each monitor area, the writing occurrence can be the value obtained when the values indicating whether or not writing occurred are totaled for each segment. Furthermore, the ratio of areas where writing occurred with respect to the monitor areas can be taken to be the writing occurrence. The period for totaling these writing occurrences can be set arbitrarily.

This kind of writing occurrence becomes a large value as the probability that writing occurred in a segment being transferred becomes high. Therefore, when employing this kind of writing occurrence, the transfer method setter 146 should execute processing similar to that in the embodiments above, for example. In other words, the transfer method setter 146 can acquire writing occurrence data and set the bulk copy transfer method for segments for which the writing occurrence indicated by the acquired writing occurrence data is equal to or greater than a threshold value, for example. Moreover, the transfer method setter 146 can set the COW transfer method, for example, for segments for which the writing occurrence indicated by the acquired writing occurrence data is less than a threshold value.

Furthermore, the writing occurrence can be value that becomes smaller as the probability that writing occurs in a segment being processing becomes high. An example of this kind of writing occurrence is the inverse of the writing frequency, writing probability or other writing occurrence that has been illustrated above. In this case, the transfer method setter can acquire the writing occurrence data, and set the bulk copy transfer method, for example, for segments for which the writing occurrence indicated by the acquired writing occurrence data is equal to or less than a threshold value. Moreover, the transfer method setter can set the COW transfer method, for example, for segments for which the writing occurrence indicated by the acquired writing occurrence data is greater than the threshold value.

Various kinds of values can be used for the writing occurrence according to the probability that writing will occur in a segment that is being transferred. The transfer method setter sets the transfer method for each segment according to the writing occurrence for the segment, and by the transfer controller 144, 244 causing the target transfer data to be transferred according to the set transfer method, it becomes possible to efficiently transfer target transfer data.

The present invention can have various forms and can be modified in various ways within the scope and range of the present invention. Moreover, the embodiments described above and for explaining the present invention, and to not limit the range of the present invention.

The portion that centers on performing the transfer process and comprises the main controller 103a (103b), main memory 104a (104b), auxiliary memory 105a, (105b) and FT controller 106a (106b) can be achieved using a normal computer system instead of a special system. For example, a sensor node that executes the processing above can be formed by storing and distributing a computer program for executing the operations above on a medium that can be read by a computer (flexible disk, CD-ROM, DVD-ROM and the like), and installing that computer program on a computer. Moreover, it is possible to form a sensor node by storing that computer program in a memory device of a server on a communication network such as the Internet, and having a normal computer system download that program.

When the sensor node function is shared by an OS (operating system) and application program, or when achieved by the OS and application program working together, it is possible to store only the application program portion on a recording medium or in a memory.

Furthermore, it is possible to superimpose the computer program on a carrier wave and distribute the program via a communication network. For example, it is possible to post the computer program on a bulletin board on a communication network (BBS, Bulletin Board Service), and distribute that program over a communication network. Construction can also be such that the processing above is executed by activating this computer program and similarly executing other application programs under the control of the OS.

Part or all of the embodiments above can be disclosed as in the following supplementary notes, but are not limited by the following.

### (Supplementary Note 1)

A data transfer device comprising;

a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and

a transfer controller that causes the data to be transferred to be transferred from a memory that stores the data to be transferred to the memory of another device according to the transfer method that was set by the transfer method setter.

### (Supplementary Note 2)

The data transfer device according to note 1, wherein

based on the value indicated by the writing occurrence data, the transfer method setter sets the transfer method, from among the transfer methods that include the first transfer method and the second transfer method, that has the smallest expected value for the writing disabled time when writing to the memory that stores the data to be transferred occurred while transferring the data.

### (Supplementary Note 3)

The data transfer device according to note 1 or note 2, wherein

the first transfer method is a transfer method that, when a transfer period for transferring data to be transferred occurs, performs a local copy of the data to be transferred, and then transfers the data to be transferred in order from the memory of that local copy destination; and

the second transfer method is a transfer method that, when a transfer period occurs, transfers the data to be transferred in order, and when a write request occurred for data of the data to be transferred that has not yet been transferred, performs a local copy of the data that has not been transferred, and then transfers the data that has not been transferred from the memory of that local copy destination.

### (Supplementary Note 4)

The data transfer device according to any one of the notes 1 to 3, wherein

the transfer method setter references writing occurrence data for each segment that divides the memory that stores the data to be transferred, and based on a value indicated by the referenced writing occurrence data, sets a transfer method that includes the first transfer method and the second transfer method for each segment; and

the transfer controller causes the data to be transferred that is included in each segment to be transferred according to the transfer method that was set by the transfer method setter.

### (Supplementary Note 5)

The data transfer device according to note 4, wherein

the transfer method setter comprises:

a writing occurrence judger that references writing occurrence data for each segment, and compares the values of each segment that are indicated by the referenced writing occurrence data with a first threshold value to determine whether or not the value of each segment is equal to or greater than the first threshold value; and

a transfer method generator that, when the writing occurrence judger determined that the value is equal to or greater than the threshold value, generates transfer method data that indicates the first transfer method as the transfer method for the segment for which judgment was performed, and when the writing occurrence judger determined that the value is less than the first threshold value, generates transfer method data that indicates the second transfer method as the transfer method for the segment for which judgment was performed; and wherein

the transfer controller causes the data to be transferred that is included in each segment, to be transferred according to the transfer method data.

### (Supplementary Note 6)

The data transfer device according to any one of the notes 1 to 5 further comprising:

a writing occurrence calculator that, for each specified period, calculates the number of times writing to the memory that stores the data to be transferred occurs and updates the writing occurrence data based on the number times writing occurred.

### (Supplementary Note 7)

The data transfer device according to note 6, wherein

the writing occurrence calculator, when a calculation period occurs for calculating the number of times writing occurred, references first dirty data that can identify transfer units, of the transfer units included in each segment that divides the memory that stores the data to be transferred, for which writing occurred between the current calculation period and the previous calculation period, and totals the number of transfer units that are identified by the first dirty data as transfer units for which writing for which writing occurred, then generates writing occurrence data from the data indicating the totaled value, and updates the writing occurrence data.

### (Supplementary Note 8)

The data transfer device according to note 6, wherein

the writing occurrence calculator, when a calculation period occurs for calculating the number of times writing has occurred, references first dirty data that can identify transfer units, of the transfer units included in each segment that divides the memory that stores the data to be transferred, for which writing occurred between the current calculation period and the previous calculation period, and second dirty data that can identify transfer units for which writing occurred between the previous calculation period and the time before the previous calculation period, and totals the number of transfer units that were identified by the first dirty data as transfer units for which writing occurred, and that were identified by the second dirty data as transfer units for which writing occurred, then generates writing occurrence data from the data indicating the totaled value, and updates the writing occurrence data.

### (Supplementary Note 9)

The data transfer device according to note 7 or note 8, wherein

the calculation period for calculating the number of times writing occurred is the transfer period for transferring data to be transferred.

### (Supplementary Note 10)

The data transfer device according to note 7 or note 8, wherein

the calculation period for calculating the number of times writing occurred is when writing to the memory that stores the data to be transferred occurred.

### (Supplementary Note 11)

The data transfer device according to any one of the notes 1 to 10, comprising

a main memory that stores part or all of the transfer method data, the writing occurrence data, the first dirty data and the second dirty data.

### (Supplementary Note 12)

The data transfer device according to any one of the notes 1 to 11 above, wherein

the transfer controller, comprises:

a transfer method judger that references the transfer method data, and determines the transfer method for each segment according to the transfer method indicated by the reference transfer method data;

a dirty unit identifier that references third dirty data that indicates for each transfer unit included in each segment whether or not writing to occurred since the previous transfer period, and identifies transfer units for which the third dirty data indicates that writing occurred; and

a transfer designator that for the data included in each segment, causes data included in the identified transfer units to be transferred.

### (Supplementary Note 13)

The data transfer device according to note 12 above, wherein

the transfer controller comprises

a local copier that, when the transfer method judger determined that the data transfer method is the first transfer method, copies the data included in the transfer units identified by the dirty unit identifier to a save area in the main memory; and

when the transfer method judger determined that the data transfer method is the first transfer method, the transfer designator causes the data that was copied into the save area by the local copier to be transferred.

### (Supplementary Note 14)

The data transfer device according to note 12 or note 13 above, wherein

the transfer method controller, comprises

a local copier that, when the transfer method judger determined that the data transfer method is the second transfer method and writing occurred to a transfer unit that was identified by the dirty unit identifier, copies data included in a transfer unit for which writing occurred to a save area in the main memory; and

when the transfer method judger determined that the data transfer method is the second transfer method and writing to a transfer unit that was identified by the dirty unit identifier occurred, the transfer designator causes the data included in the transfer unit for which writing occurred to be transferred after the data has been copied by the local copier, and when writing to a transfer unit that was identified by the dirty unit identifier did not occur, the transfer designator causes the data included in the transfer unit for which writing did not occur to be transferred.

### (Supplementary Note 15)

An FT server, comprising:

a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and

a transfer controller that causes the data to be transferred to be transferred from a memory that stores the data to be transferred to the memory of another device according to the transfer method that was set by the transfer method setter.

### (Supplementary Note 16)

A data transfer method that

references writing occurrence data that indicates a value according to the probability that writing to the memory where the data to be transferred will occur while data is being transferred;

sets a transfer method that is either a first transfer method or a second transfer method that is different from the first transfer method based on the value that is indicated by the referenced writing occurrence data; and

causes the data to be transferred to be transferred from a memory that stores the data to be transferred to a memory of another device according to the set transfer method.

### (Supplementary Note 17)

A program that causes a computer to

reference writing occurrence data that indicates a value according to the probability that writing to the memory where the data to be transferred will occur while data is being transferred;

set a transfer method that is either a first transfer method or a second transfer method that is different from the first transfer method based on the value that is indicated by the referenced writing occurrence data; and

cause the data to be transferred to be transferred from a memory that stores the data to be transferred to a memory of another device according to the set transfer method.

### (Supplementary Note 18)

A memory medium that can be read by a computer and that stores a program that causes a computer to

reference writing occurrence data that indicates a value according to the probability that writing to the memory where the data to be transferred will occur while data is being transferred;

set a transfer method that is either a first transfer method or a second transfer method that is different from the first transfer method based on the value that is indicated by the referenced writing occurrence data; and

cause the data to be transferred to be transferred from a memory that stores the data to be transferred to a memory of another device according to the set transfer method.

The present invention is suitable for application in a fault tolerant system.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A data transfer device comprising;
a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and
a transfer controller that causes the data to be transferred to be transferred from a memory that stores the data to be transferred to the memory of another device according to the transfer method that was set by the transfer method setter.

2. The data transfer device according to claim 1, wherein
based on the value indicated by the writing occurrence data, the transfer method setter sets the transfer method, from among the transfer methods that include the first transfer method and the second transfer method, that has the smallest expected value for the writing disabled time when writing to the memory that stores the data to be transferred occurred while transferring the data.

3. The data transfer device according to claim 1, wherein
the first transfer method is a transfer method that, when a transfer period for transferring data to be transferred occurs, performs a local copy of the data to be transferred, and then transfers the data to be transferred in order from the memory of that local copy destination; and
the second transfer method is a transfer method that, when a transfer period occurs, transfers the data to be transferred in order, and when a write request occurred for data of the data to be transferred that has not yet been transferred, performs a local copy of the data that has not been transferred, and then transfers the data that has not been transferred from the memory of that local copy destination.

4. The data transfer device according to claim 2, wherein
the first transfer method is a transfer method that, when a transfer period for transferring data to be transferred occurs, performs a local copy of the data to be transferred, and then transfers the data to be transferred in order from the memory of that local copy destination; and
the second transfer method is a transfer method that, when a transfer period occurs, transfers the data to be transferred in order, and when a write request occurred for data of the data to be transferred that has not yet been transferred, performs a local copy of the data that has not been transferred, and then transfers the data that has not been transferred from the memory of that local copy destination.

5. The data transfer device according to claim 1, wherein
the transfer method setter references writing occurrence data for each segment that divides the memory that stores the data to be transferred, and based on a value indicated by the referenced writing occurrence data, sets a transfer method that includes the first transfer method and the second transfer method for each segment; and
the transfer controller causes the data to be transferred that is included in each segment to be transferred according to the transfer method that was set by the transfer method setter.

6. The data transfer device according to claim 2, wherein
the transfer method setter references writing occurrence data for each segment that divides the memory that stores the data to be transferred, and based on a value indicated by the referenced writing occurrence data, sets a transfer method that includes the first transfer method and the second transfer method for each segment; and
the transfer controller causes the data to be transferred that is included in each segment to be transferred according to the transfer method that was set by the transfer method setter.

7. The data transfer device according to claim 3, wherein
the transfer method setter references writing occurrence data for each segment that divides the memory that stores the data to be transferred, and based on a value indicated by the referenced writing occurrence data, sets a transfer method that includes the first transfer method and the second transfer method for each segment; and
the transfer controller causes the data to be transferred that is included in each segment to be transferred according to the transfer method that was set by the transfer method setter.

8. The data transfer device according to claim 5, wherein
the transfer method setter comprises:
a writing occurrence judger that references writing occurrence data for each segment, and compares the values of each segment that are indicated by the referenced writing occurrence data with a first threshold value to determine whether or not the value of each segment is equal to or greater than the first threshold value; and
a transfer method generator that, when the writing occurrence judger determined that the value is equal to or greater than the threshold value, generates transfer method data that indicates the first transfer method as the transfer method for the segment for which judgment was performed, and when the writing occurrence judger determined that the value is less than the first threshold value, generates transfer method data that indicates the second transfer method as the transfer method for the segment for which judgment was performed; and wherein
the transfer controller causes the data to be transferred that is included in each segment, to be transferred according to the transfer method data.

9. The data transfer device according to claim 1 further comprising:
a writing occurrence calculator that, for each specified period, calculates the number of times writing to the memory that stores the data to be transferred occurs and updates the writing occurrence data based on the number times writing occurred.

10. The data transfer device according to claim 2 further comprising:
a writing occurrence calculator that, for each specified period, calculates the number of times writing to the memory that stores the data to be transferred occurs and updates the writing occurrence data based on the number times writing occurred.

11. The data transfer device according to claim 3 further comprising:
a writing occurrence calculator that, for each specified period, calculates the number of times writing to the memory that stores the data to be transferred occurs and updates the writing occurrence data based on the number times writing occurred.

12. The data transfer device according to claim 5 further comprising:
ng occurrence calculator that, for each specified period, calculates the number of times writing to the memory that stores the data to be transferred occurs and updates the writing occurrence data based on the number times writing occurred.

13. The data transfer device according to claim 8 further comprising:
a writing occurrence calculator that, for each specified period, calculates the number of times writing to the memory that stores the data to be transferred occurs and updates the writing occurrence data based on the number times writing occurred.

14. The data transfer device according to claim 9, wherein
the writing occurrence calculator, when a calculation period occurs for calculating the number of times writing occurred, references first dirty data that can identify transfer units, of the transfer units included in each segment that divides the memory that stores the data to be transferred, for which writing occurred between the current calculation period and the previous calculation period, and totals the number of transfer units that are identified by the first dirty data as transfer units for which writing for which writing occurred, then generates writing occurrence data from the data indicating the totaled value, and updates the writing occurrence data.

15. The data transfer device according to claim 9, wherein
the writing occurrence calculator, when a calculation period occurs for calculating the number of times writing has occurred, references first dirty data that can identify transfer units, of the transfer units included in each segment that divides the memory that stores the data to be transferred, for which writing occurred between the current calculation period and the previous calculation period, and second dirty data that can identify transfer units for which writing occurred between the previous calculation period and the time before the previous calculation period, and totals the number of transfer units that were identified by the first dirty data as transfer units for which writing occurred, and that were identified by the second dirty data as transfer units for which writing occurred, then generates writing occurrence data from the data indicating the totaled value, and updates the writing occurrence data.

16. The data transfer device according to claim 14, wherein
the calculation period for calculating the number of times writing occurred is the transfer period for transferring data to be transferred.

17. The data transfer device according to claim 15, wherein
the calculation period for calculating the number of times writing occurred is the transfer period for transferring data to be transferred.

18. The data transfer device according to claim 14, wherein
the calculation period for calculating the number of times writing occurred is when writing to the memory that stores the data to be transferred occurred.

19. An FT server, comprising:
a transfer method setter that references writing occurrence data that is a value that corresponds to the probability that writing to memory that stores data to be transferred will occur during the data transfer process, and based on the value indicated by the referenced writing occurrence data, sets a transfer method that includes a first transfer method and a second transfer method that is different than the first transfer method; and
a transfer controller that causes the data to be transferred to be transferred from a memory that stores the data to be transferred to the memory of another device according to the transfer method that was set by the transfer method setter.

20. A data transfer method that
references writing occurrence data that indicates a value according to the probability that writing to the memory where the data to be transferred will occur while data is being transferred;
sets a transfer method that is either a first transfer method or a second transfer method that is different from the first transfer method based on the value that is indicated by the referenced writing occurrence data; and
causes the data to be transferred to be transferred from a memory that stores the data to be transferred to a memory of another device according to the set transfer method.
